(19) United States
(12) Patent Application Publication
(10) Pub. No.: US 2019/0075546 A1
(43) Pub. Date: Mar. 7, 2019

(54) USER APPARATUS, BASE STATION, SIGNAL TRANSMISSION METHOD, AND RESOURCE ALLOCATION METHOD

(71) Applicant: NTT DOCOMO, INC., Tokyo (JP)

(72) Inventors: Shimpei Yasukawa, Tokyo (JP); Satoshi Nagata, Tokyo (JP); Qun Zhao, Beijing (CN); Yongsheng Zhang, Beijing (CN)

(73) Assignee: NTT DOCOMO, INC., Tokyo (JP)

(21) Appl. No.: 15/767,204

(22) PCT Filed: Oct. 31, 2016
(86) PCT No.: PCT/JP2016/082260

§ 371 Date: Apr. 10, 2018

(30) Foreign Application Priority Data
Nov. 5, 2015 (JP) 2015-218012

(51) Int. Cl. H04W 72/02; H04W 72/04; H04W 76/14

(52) U.S. Cl. CPC H04W 72/02; H04W 76/14; H04W 72/042; H04W 72/0413

(57) ABSTRACT

A user apparatus is disclosed in a radio communication system that supports a D2D communication. The user apparatus includes a selector that selects a first resource for transmitting control information in a first carrier and a second resource for transmitting data in a second carrier, and a transmitter that transmits control information that includes information to specify the second resource using the first resource and to transmit data using the second resource. A base station is also disclosed in a radio communication system that supports a D2D communication. The base station includes a selector that allocates a first resource to transmit control information in a first carrier for the D2D communication and a second resource to transmit data in a second carrier for the D2D communication to a user apparatus, and a transmitter configured to transmit resource allocation information to indicate the first resource and the second resource.

### CROSS REFERENCE TO RELATED APPLICATIONS

The present application is a national phase application of PCT/JP2016/082260 filed on Oct. 31, 2016, which claims priority to Japanese Patent Application No. 2015-218012, filed on Nov. 5, 2015. The contents of these applications are hereby incorporated by reference in their entirety.

### FIELD OF THE INVENTION

The present invention relates to a user apparatus, a base station, a signal transmission method, and a resource allocation method.

### BACKGROUND

In Long Term Evolution (LTE) and a successor system to LTE (for example, also referred to as LTE Advanced (LTE-A), Future Radio Access (FRA), 4^{TH} Generation Mobile communication System (4G), and the like), a Device to Device (D2D) technique, that performs a direct communication between user apparatuses without intervention by a radio base station, is under study (See Non-Patent Document 1).

The D2D technique can reduce traffic between the user apparatus and the base station, and the D2D technique can enable the communication between the user apparatuses even in a case in which the base station becomes incommunicable at a time of a disaster and the like.

The D2D technique can be classified into a D2D discovery for discovering another communicable user apparatus, and a D2D direct communication (also referred to as a D2D communication, an inter-terminal direct communication, and the like) for directly communicating between the user apparatuses. In the following, the D2D communication, the D2D discovery, and the like will simply be referred to as the D2D when not distinguishing each other. In addition, a signal transmitted and received by the D2D will be referred to as a D2D signal.

Further, in the 3rd Generation Partnership Project (3GPP), realizing Vehicle to Everything (V2X) by extending the D2D function is under study. The V2X is a part of Intelligent Transport Systems (ITS), and is a generic name for Vehicle to Vehicle (V2V) that is a communication configuration between an automobile and another automobile, Vehicle to Infrastructure (V2I) that is a communication configuration between the automobile and an Road-Side Unit (RSU) set on a roadside, Vehicle to Nomadic device (V2N) that is a communication configuration between the automobile and a mobile terminal of a driver, and Vehicle to Pedestrian (V2P) that is a communication configuration between the automobile and a mobile terminal of a pedestrian.

### PRIOR ART DOCUMENTS

Non-Patent Document 1: “Key driver for LTE success: Services Evolution”, September 2011, 3GPP, Internet URL: http://www.3gpp.org/ftp/Information/presentations/presentations_2011/2011_09_LTE_Asia/20 11_LTE-Asia_3GPP_Service_evolution.pdf

### SUMMARY OF THE INVENTION

In accordance with one or more embodiments of the invention, a user apparatus in a radio communication system that supports D2D communication includes a selector that selects a first resource to transmit control information in a first carrier, and a second resource to transmit data in a second carrier. The user apparatus also includes a transmitter that transmits control information that includes information to specify the second resource using the first resource, and the transmitter transmits data using the second resource.

In some aspects, the selector selects the first resource in a resource pool for control information in the first carrier, and selects the second resource in a resource pool for data in the second carrier that corresponds to the resource pool for control information in the first carrier.

In some aspects, the control information includes information that specifies the second carrier.

In some aspects, the selector further selects a third resource to transmit data in the first carrier, the control information further includes information that specifies the third resource, and the transmitter further transmits data using the third resource.

In some aspects, the control information includes information that indicates whether the data transmitted using the second resource, and the data transmitted using the third resource are different data.

In some aspects, the control information includes information that indicates whether the data transmitted using the second resource, and the data transmitted using the third resource are identical data.

In some aspects, the selector selects a third resource to transmit data in the first carrier in a time region identical to that of the first resource, and the transmitter further transmits data using the third resource.

In accordance with one or more embodiments of the invention, a base station in a radio communication system that supports D2D communication includes a selector that allocates a first resource to transmit control information in a first carrier for the D2D communication, and a second resource to transmit data in a second carrier for the D2D communication, to a user apparatus; and a transmitter configured to transmit resource allocation information to indicate the first resource and the second resource to the user apparatus.

In some aspects, the resource allocation information includes information that specifies the first carrier to which the first resource is allocated, and information that specifies the second carrier to which the second resource is allocated.

In accordance with one or more embodiments of the invention, a signal transmission method executed by a user apparatus in a radio communication system that supports a D2D communication includes selecting a first resource for transmitting control information in a first carrier, and a second resource for transmitting data in a second carrier; and transmitting control information including information specifying the second resource using the first resource, and transmitting data using the second resource.

In accordance with one or more embodiments of the invention, a resource allocation method executed by a base station in a radio communication system that supports a D2D communication includes allocating a first resource for transmitting control information in a first carrier for the D2D communication, and a second resource for transmitting data in a second carrier for the D2D communication, to a user apparatus; and transmitting resource allocation information indicating the first resource and the second resource to the user apparatus.

### BRIEF DESCRIPTION OF THE DRAWING

FIG. 1A is a diagram for explaining a problem.

FIG. 1B is a diagram for explaining a problem.

FIG. 1C is a diagram for explaining a problem.

FIG. 2A is a diagram for explaining the D2D.

FIG. 2B is a diagram for explaining the D2D.

FIG. 3 is a diagram for explaining a MAC PDU used for the D2D communication.

FIG. 4 is a diagram for explaining a format of an SL-SCH subheader.

FIG. 5 is a diagram for explaining an example of a channel configuration used in the D2D.

FIG. 6A is a diagram illustrating an example of a configuration of a PSDCH.

FIG. 6B is a diagram illustrating an example of the configuration of the PSDCH.

FIG. 7A is a diagram illustrating examples of configurations of a PSCCH and a PSSCH.

FIG. 7B is a diagram illustrating examples of the configurations of the PSCCH and the PSSCH.

FIG. 8A is a diagram illustrating a resource pool configuration.

FIG. 8B is a diagram illustrating the resource pool configuration.

FIG. 9 is a diagram illustrating an example of a configuration of a radio communication system in one or more embodiments of the invention.

FIG. 10 is a diagram for explaining a D2D signal transmission method in a first embodiment of the invention.

FIG. 11 is a diagram for explaining the D2D signal transmission method in a second embodiment of the invention.

FIG. 12 is a diagram for explaining the D2D signal transmission method in a third embodiment of the invention.

FIG. 13 is a diagram for explaining an example of a method of setting the resource pool in the third embodiment of the invention.

FIG. 14 is a diagram for explaining the D2D signal transmission method in a fourth embodiment of the invention.

FIG. 15A is a diagram for explaining a resource allocation method in a fifth embodiment of the invention.

FIG. 15B is a diagram for explaining the resource allocation method in the fifth embodiment of the invention.

FIG. 15C is a diagram for explaining the resource allocation method in the fifth embodiment of the invention.

FIG. 16 is a diagram illustrating an example of a functional configuration of a user apparatus in accordance with one or more embodiments of the invention.

FIG. 17 is a diagram illustrating an example of a functional configuration of a base station in accordance with one or more embodiments of the invention.

FIG. 18 is a diagram illustrating an example of a hardware configuration of the user apparatus in accordance with one or more embodiments of the invention.

FIG. 19 is a diagram illustrating an example of a hardware configuration of the base station in accordance with one or more embodiments of the invention.

### DETAILED DESCRIPTION

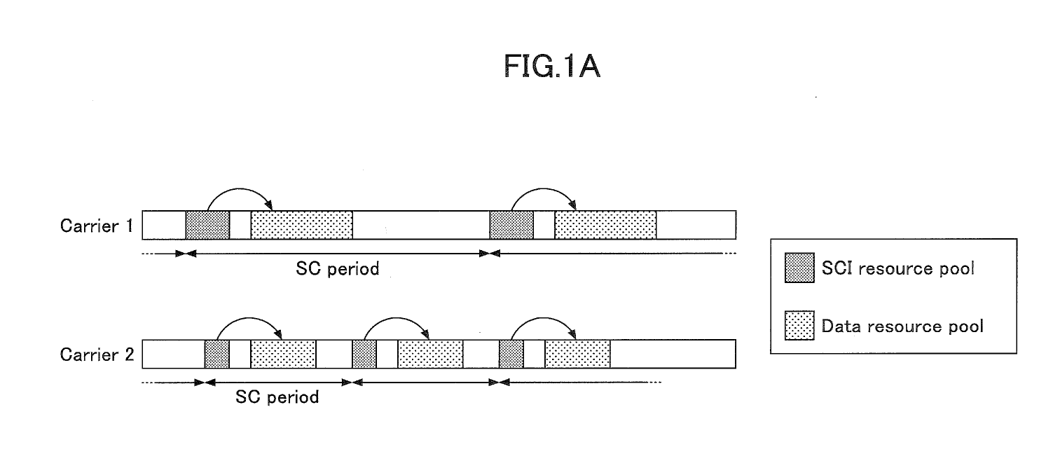

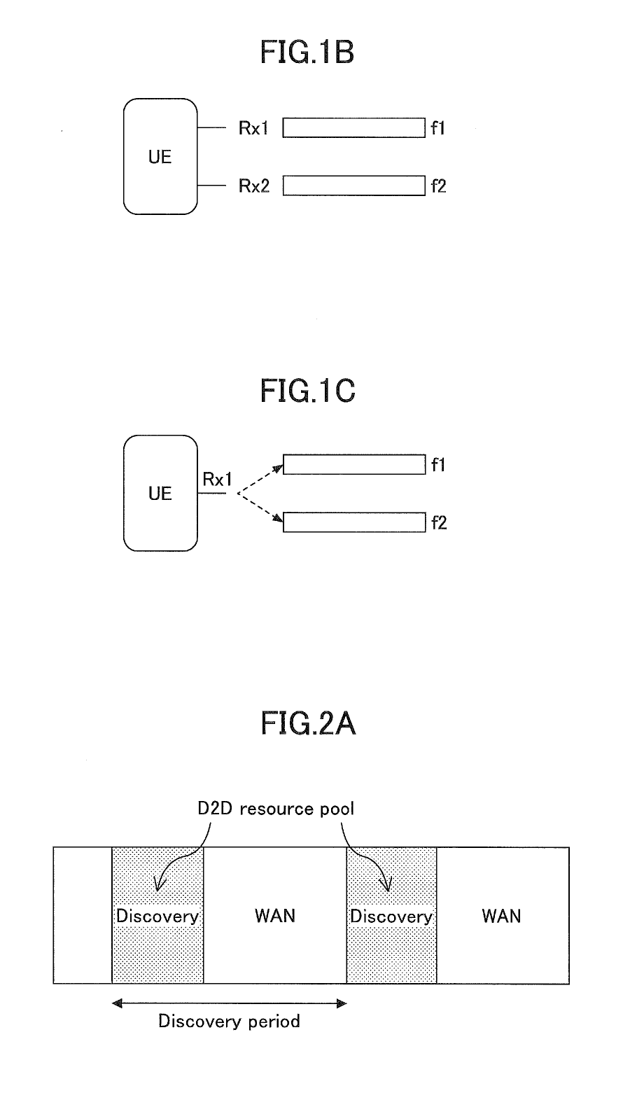

A brief description will be given of a current D2D technique (D2D technique of resource 12). For example, as illustrated in FIG. 1A, in the “D2D communication”, a resource pool for Sidelink Control Information (SCI) and/or data transmission is periodically secured. This period of time is referred to as a Sidelink Control (SC) period. A user apparatus on a transmission end notifies a resource for data transmission and the like to a reception end by the SCI using the resource selected from the resource pool for SCI transmission, and transmits the data using the resource for data transmission. The resource for data transmission is selected from the resource pool for data transmission. The resource pool for SCI transmission and the resource pool for data transmission are set within the same carrier. The user apparatus on the reception end receives the SCI by monitoring the resource pool for SCI transmission, and receives the data by monitoring the resource specified by the received SCI to perform demodulation and the like.

In V2X, performing the D2D communication between the user apparatuses using a plurality of carriers is under study. In a case in which the user apparatus performs the D2D communication with another user apparatus using the plurality of carriers, the resource pool for SCI transmission requires monitoring at each of the plurality of carriers. For example, assume a case in which the user apparatus performs the D2D communication with the other user apparatus using a carrier 1 and a carrier 2, as illustrated in FIG. 1A. In this case, the user apparatus on the reception end needs to monitor the resource pool for the SCI transmission of the carrier 1 in order to receive the data transmitted by the carrier 1, and needs to monitor the resource pool for the SCI transmission of the carrier 2 in order to receive the data transmitted by the carrier 2.

In a case in which the user apparatus is capable of simultaneously receiving 2 frequencies (carriers) as illustrated in FIG. 1B, the user apparatus can simultaneously monitor the resource pools for SCI transmission of the carrier 1 and the carrier 2. However, simultaneously monitoring a plurality of frequencies causes power consumption of the user apparatus to increase. In addition, in general, the cost of the user apparatus capable of simultaneously receiving the plurality of frequencies is high.

In a case in which the user apparatus is capable of receiving only a single frequency as illustrated in FIG. 1C, the user apparatus needs to monitor the resource pool of SCI transmission of one of the carriers by switching between the carrier 1 and the carrier 2. However, as illustrated in FIG. 1A, in a case in which timings of the resource pool of the carrier 1 and the resource pool of the carrier 2 overlap, the user apparatus can only monitor one of the resource pools, and cannot receive the SCI and data transmitted by the carrier that is not monitored resulting in the loss of the SCI and the data transmitted.

When the user apparatus on the reception end performs the D2D communication by monitoring the resource pool for SCI transmission while switching the plurality of carriers, procedures of the process become complex and inappropriate. In addition, the user apparatus on the transmission end needs to select the carrier for transmitting the SCI, and procedures of the process become complex and inappropriate.

Considering that V2X is a type of the D2D, the problem described above occurs not only in V2X but also in the D2D in general.

The disclosed technique is conceived to appropriately perform a D2D communication in a case in which the D2D communication is performed using a plurality of carriers in a radio communication system that supports the D2D.

According to the disclosed technique, a user apparatus in a radio communication system that supports a D2D communication, includes a selector configured to select a first resource for transmitting control information in a first carrier, and a second resource for transmitting data in a second carrier; and a transmission part configured to transmit control information including information specifying the second resource using the first resource, and transmit data using the second resource.

In addition, according to the disclosed technique, a base station in a radio communication system that supports a D2D communication, includes a selector configured to allocate a first resource for transmitting control information in a first carrier for the D2D communication, and a second resource for transmitting data in a second carrier for the D2D communication, to a user apparatus; and a transmission part configured to transmit resource allocation information indicating the first resource and the second resource to the user apparatus.

According to the disclosed technique, in a case in which a D2D communication is performed using a plurality of carriers in a radio communication system that supports the D2D, it is possible to provide a technique to appropriately perform the D2D communication.

A description will hereinafter be given of one or more embodiments of the present invention by referring to the drawings. The embodiments described in the following are merely examples, and embodiments to which the present invention may be applied are not limited to the following embodiments. For example, in these embodiments, it is assumed that a radio communication system is in conformance with LTE, however, the present invention is not limited to LTE, and is applicable to other systems. In this specification, “LTE” is used in a broad sense to include communication systems of the 3GPP releases 12 and 13, or a fifth generation communication system corresponding to a successor system of the 3GPP release 14.

In addition, these embodiments are not limited to the V2X, and they are broadly applicable to the D2D in general. Further, “D2D” is used in the sense to include the V2X.

Moreover, “D2D” is used in a broad sense to include not only a processing procedure to transmit and receive the D2D signal between the user apparatus UEs, but also a processing procedure to receive (monitor) the D2D signal by the base station, and a processing procedure to transmit an uplink signal from the user apparatus UE to the base station eNB in a case of a Radio Resource Control (RRC) idle or in a case in which a connection is not established with the base station eNB.

<About D2D>

A general description will be given of the D2D prescribed in the LTE. The D2D technique described below may also be used in V2X, and the UE in one or more embodiments of the present invention may transmit and receive the D2D signal according to this technique.

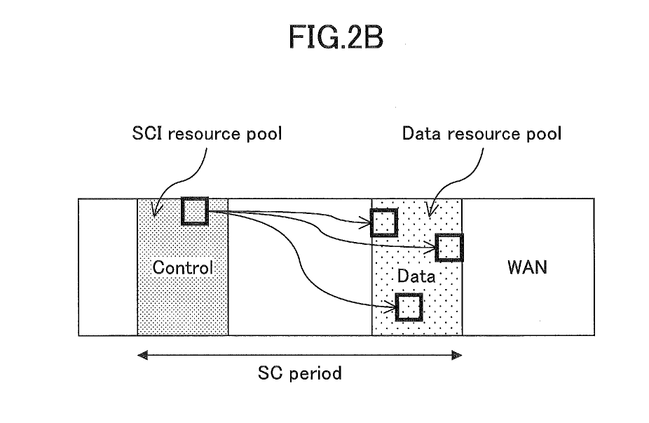

As described above, the D2D can generally be classified into the “D2D discovery” and the “D2D communication”. In the case of the “D2D discovery”, as illustrated in FIG. 2A, a resource pool for a discovery message is secured for every discovery period, and the UE transmits the discovery message within this resource pool. More particularly, there are Type 1 and Type 2b. According to Type 1, the UE autonomously selects a transmission resource from the resource pool. According to Type 2b, a semi-static resource is allocated by a higher layer signaling (for example, an RRC signal).

In the case of the “D2D communication”, as illustrated in FIG. 2B, a resource pool for SCI and/or data transmission is periodically secured. The UE on the transmission end notifies the resource for data transmission and the like by a resource selected from the control resource pool (resource pool for SCI transmission), and transmits the data by this resource for data transmission. More particularly, in the case of the “D2D communication”, there are Mode 1 and Mode 2. According to Mode 1, a resource is dynamically allocated by (E) Physical Downlink Control Channel (PDCCH) transmitted from the eNB to the UE. According to Mode 2, the UE autonomously selects a resource for transmission from the resource pool. The resource pool may be notified by a signal of the broadcast information (SIB), or the resource pool that is used may be predefined.

In the LTE, a channel used by the “D2D discovery” is referred to as a Physical Sidelink Discovery Channel (PSDCH), a channel for transmitting the control information such as the SCI and the like in the “D2D communication” is referred to as a Physical Sidelink Control Channel (PSCCH), and a channel for transmitting the data is referred to as a Physical Sidelink Shared Channel (PSSCH) (See Non-Patent Document 2).

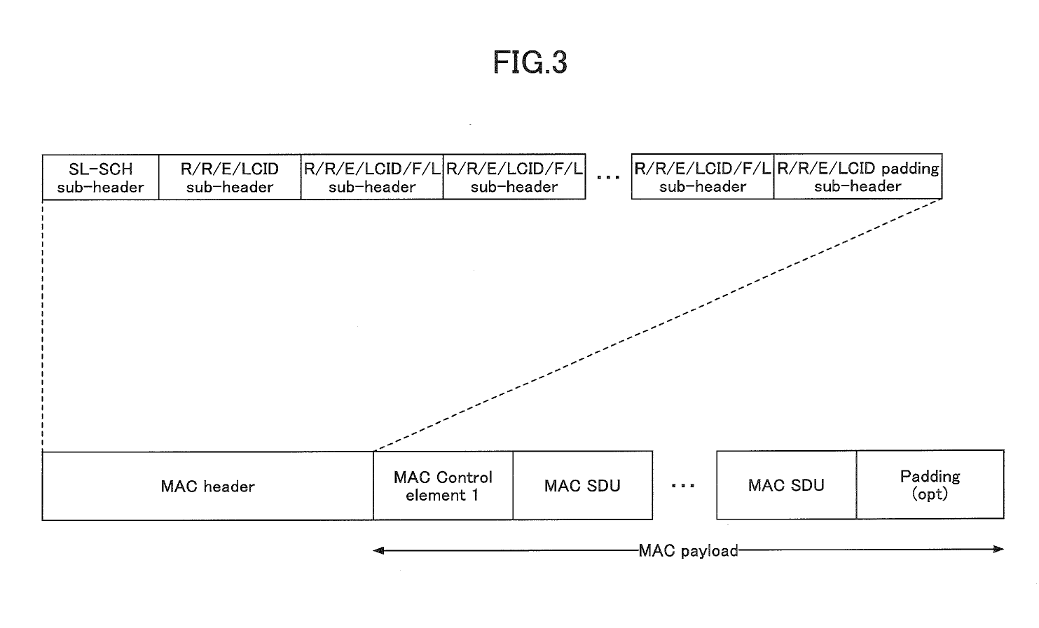

A Medium Access Control (MAC) Protocol Data Unit (PDU) used for the D2D communication is formed by at least a MAC header, a MAC control element, a MAC Service Data Unit (SDU), and a padding, as illustrated in FIG. 3. The PDU may include other information. The MAC header is formed by 1 Sidelink Shared Channel (SL-SCH) sub-header, and 1 or more MAC PDU sub-headers.

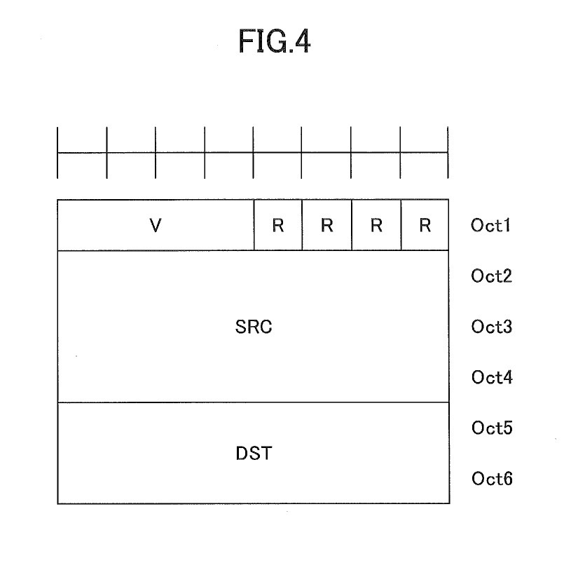

As illustrated in FIG. 4, the SL-SCH sub-header is formed by a MAC PDU format version (V), a transmission source information (SRC), a transmission destination information (DST), a reserved bit (R), and the like. The V is allocated to a head of the SL-SCH sub-header, and indicates the MAC PDU format version used by the UE. The transmission source information is set with information related to a transmission source. The transmission source information may be set with an identifier related to a Proximity-services (ProSe) UE ID. The transmission destination information is set with information related to a transmission destination. The transmission destination information may be set with information related to a ProSe Layer-2 Group ID of the transmission destination.

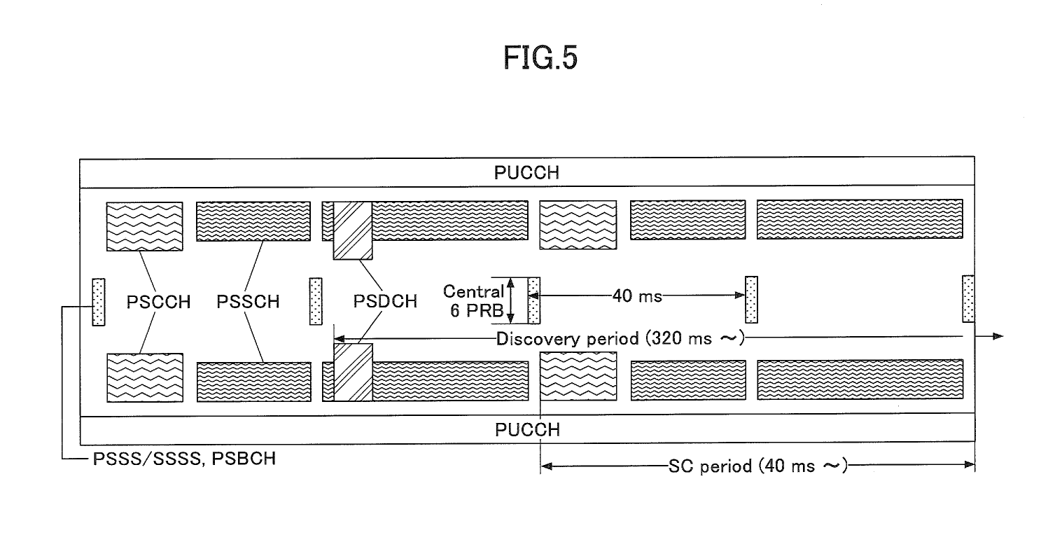

FIG. 5 illustrates an example of a channel configuration of the D2D. As illustrated in FIG. 5, a PSCCH resource pool and a PSSCH resource pool used for the “D2D communication” are allocated to the channel. In addition, a PSDCH resource pool used for the “D2D discovery” is allocated to the channel with a period that is longer than a period of the channel of the “D2D communication”.

In addition, a Primary Sidelink Synchronization Signal (PSSS) and an Secondary Sidelink Synchronization Signal (SSSS) are used as synchronization signals for the D2D. Further, for operation outside a coverage area, for example, a

Physical Sidelink Broadcast Channel (PSBCH) is used to transmit broadcast information such as a system band of the D2D, a frame number, resource configuration information, and the like.

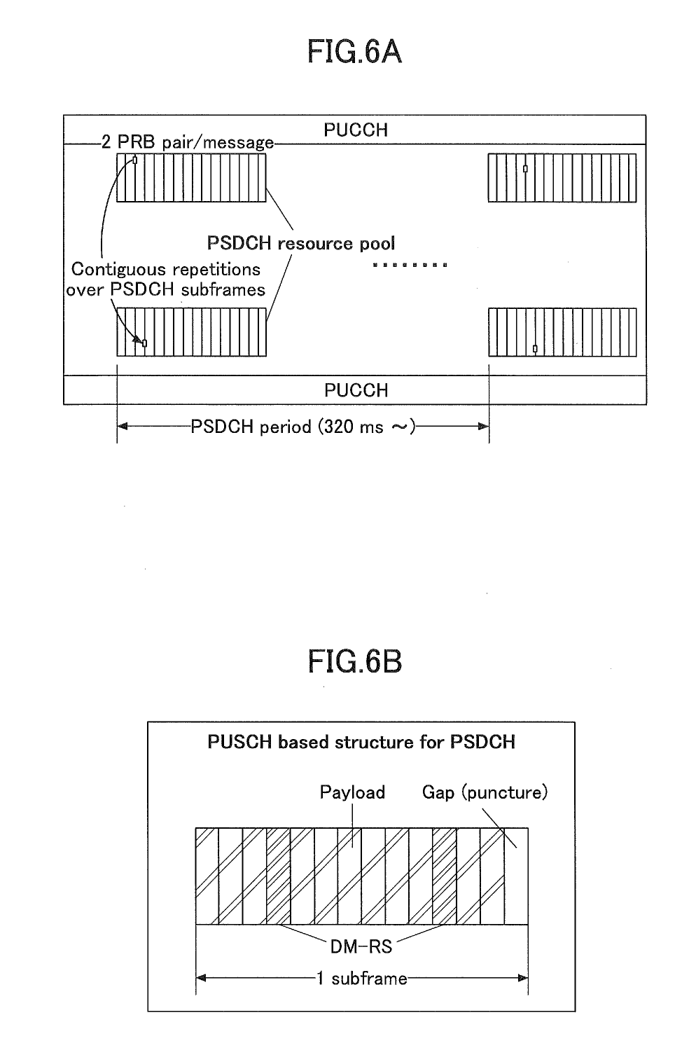

FIG. 6A illustrates an example of the PSDCH resource pool used for the “D2D discovery”. Because the resource pool is set with a bitmap of the sub-frame, an image of the resource pool becomes as illustrated in FIG. 6A. Resource pools of other channels may be similar to the above. In addition, the PSDCH is transmitted in repetition while frequency hopping. A number of repetitions may be set to 0 to 4, for example. Further, as illustrated in FIG. 6B, the PSDCH has a Physical Uplink Shared Channel (PUSCH) based configuration in which a Demodulation Reference Signal (DMRS) is inserted.

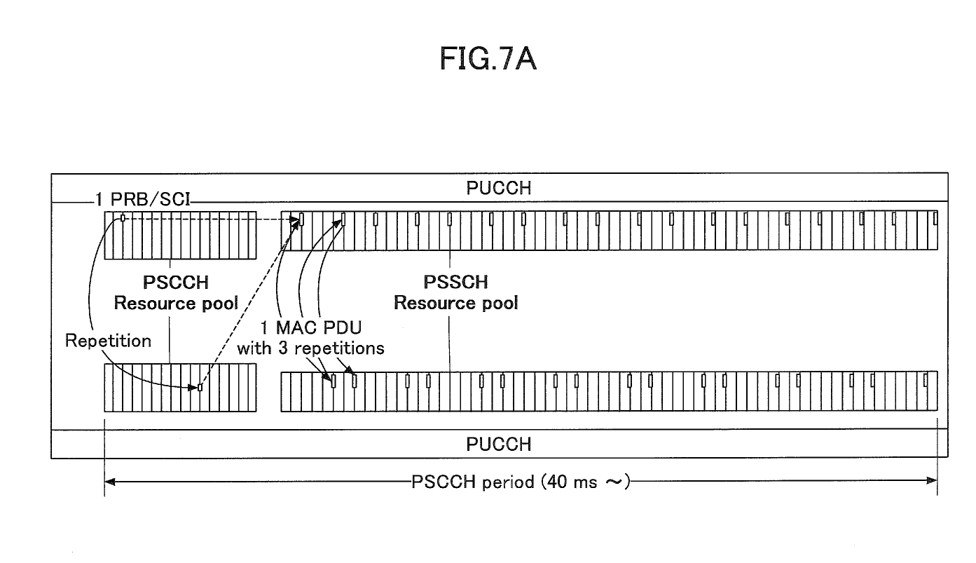

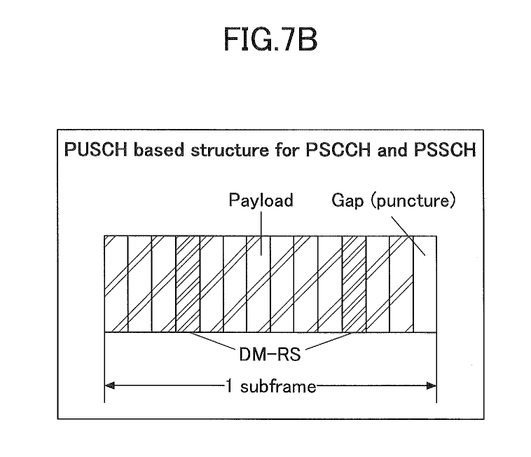

FIG. 7A illustrates examples of the PSCCH and PSSCH used for the “D2D communication”. As illustrated in FIG. 7A, the PSCCH is transmitted with 1 repetition while frequency hopping. The PSSCH is transmitted with 3 repetitions while frequency hopping. In addition, as illustrated in FIG. 7B, the PSCCH and the PSSCH have a PUSCH based configuration in which a DMRS is inserted.

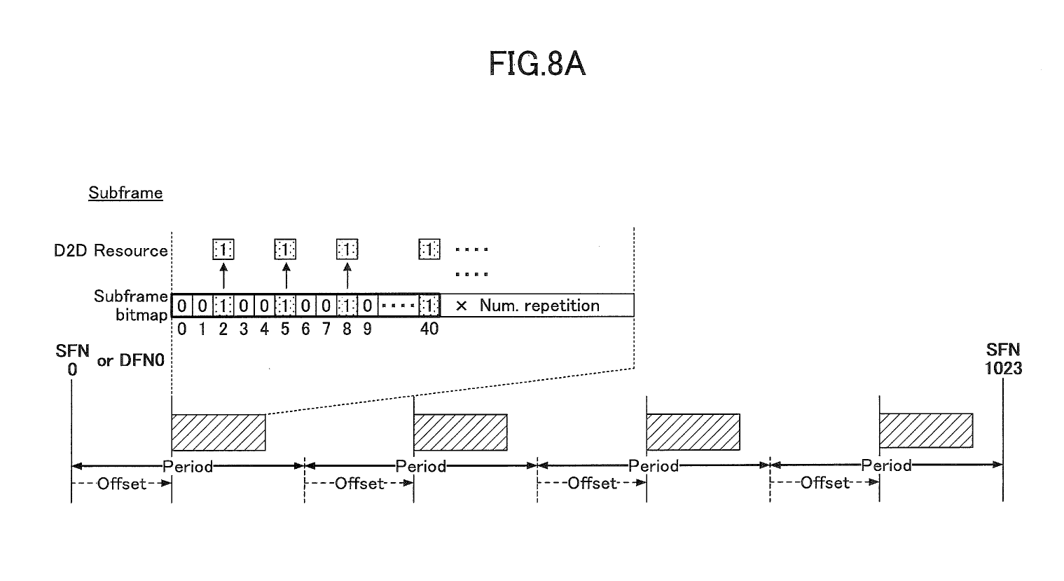

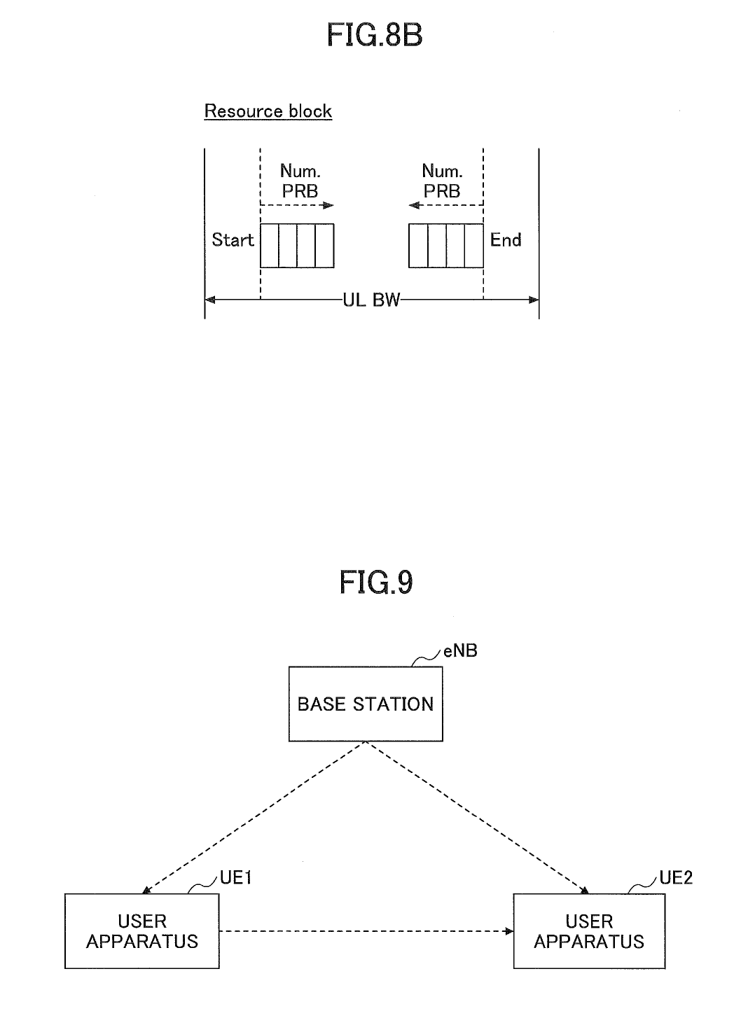

FIG. 8A and FIG. 8B illustrate examples of resource pool configurations of the PSCCH, the PSDCH, and the PSSCH (Mode 2). As illustrated in FIG. 8A, the resource pool is represented as a sub-frame bitmap in a time direction. In addition, the bitmap is repeated by the number of repetitions (num.repetition). Further, an offset indicating a start position of each period is defined.

In a frequency direction, a contiguous allocation and a non-contiguous allocation are possible. FIG. 8B illustrates an example of the non-contiguous allocation, and as illustrated in FIG. 8B, a start Physical Resource Block (PRB), an end PRB, and a number of PRBs (num.PRB) are specified.

<System Configuration>

FIG. 9 is a diagram illustrating an example of a configuration of a radio communication system in this embodiment. As illustrated in FIG. 9, the radio communication system in this embodiment includes a base station eNB, a user apparatus UE1, and a user apparatus UE2. In FIG. 9, the user apparatus UE1 is illustrated as the transmission end and the user apparatus UE2 is illustrated as the reception end, however, the user apparatus UE1 and the user apparatus UE2 may be provided with both a transmission function and a reception function. In the following example embodiment, the user apparatus UE1 and the user apparatus UE2 will simply be referred to as the “user apparatus UE” when not distinguishing each other. In this example embodiment, the communication of the data and the like between the user apparatuses UEs is performed without intervention by the base station eNB.

The user apparatus UE1 and the user apparatus UE2 illustrated in FIG. 9 include a cellular communication function of the user apparatus UE in the LTE, and a D2D function including the signal transmission and reception in the channel described above. In addition, the user apparatus UE1 and the user UE2 include functions to execute the operation of this example embodiment described below. With regard to the cellular communication function and the existing D2D function, only a part of the functions (to an extent capable of executing the operation of this embodiment described hereunder) may be provided, or all of the functions may be provided.

In addition, each user apparatus UE may be any apparatus including the D2D function. For example, each user apparatus UE may be a terminal carried by a vehicle or a pedestrian, an RSU (UE type RSU including UE functions), and the like.

Further, the base station eNB includes a cellular communication function of the base station eNB of the LTE, and a function (a resource allocation function, a setting information notification function, and the like) for enabling the communication of the user apparatus UE in this embodiment. Moreover, the base station eNB includes an RSU (eNB type RSU including eNB functions).

The ratio communication system in this example embodiment includes a plurality of carriers usable for the D2D communication, however, the plurality of carriers may be formed by a single base station eNB, or formed by a plurality of base stations eNBs. In addition, the plurality of carriers may be formed by an Remote Radio Head (RRH).

<Operation>

In this example embodiment, in a case in which a plurality of carriers for the D2D are usable and the data is transmitted using one or more carriers of the plurality of carriers, the transmission end user apparatus UE1 operates so as to transmit the SCI specifying the resource and the like of the carrier that transmits the data using a specific carrier of the plurality of carriers. In addition, in a case in which a resource pool for SCI transmission of the specific carrier is monitored and the SCI is received, the reception end user apparatus UE2 receives the data by monitoring the resource of the carrier corresponding to the SCI. In other words, the transmission end user apparatus UE1 selects the resource that transmits the data from resources of the one or more carriers, and notifies the selected resource to the reception end user apparatus UE2 using the specific carrier.

In the following description, the resource pool for SCI transmission is referred to as the “SCI resource pool” for the sake of convenience. In addition, the resource pool for data transmission is referred to as the “data resource pool” for the sake of convenience.

In the following example embodiment, a description will be separately given for a first embodiment, a second embodiment, a third embodiment, a fourth embodiment, and a fifth embodiment.

The user apparatus UE in this example embodiment includes the functions of the system according to the first embodiment to the system according to the fifth embodiment. The system used for the transmission may be determined from the setting information (configuration information) of the eNB, for example. In addition, the user apparatus UE itself may determine the system of the embodiment that is to be executed. These are mere examples, and the user apparatus UE may cope with only one of the systems of the first embodiment to the system of the fifth embodiment, or cope with only a part of the systems.

### First Embodiment

In the first embodiment, a transmission end user apparatus UE1 transmits the SCI by the SCI resource pool of a specific carrier. In addition, a reception end user apparatus UE2 recognizes the carrier of the data to which the received SCI is related by using a corresponding relationship between the SCI resource pool and the data resource pool.

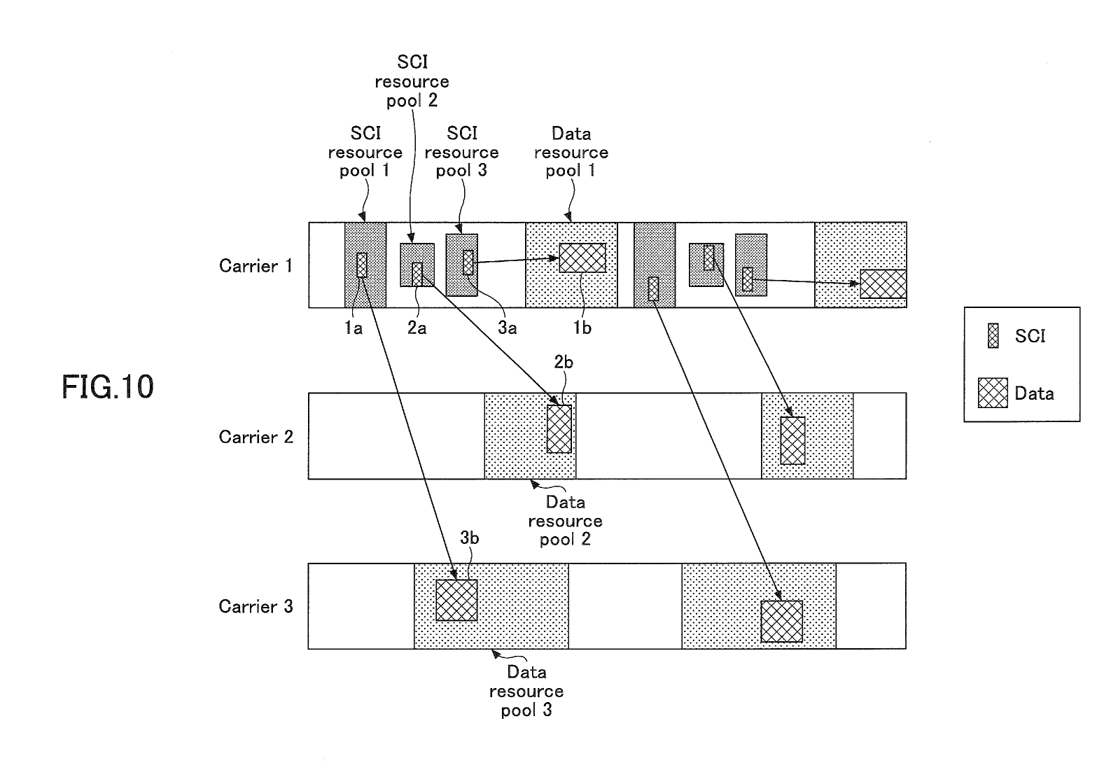

FIG. 10 is a diagram for explaining a D2D signal transmission method in the first embodiment. In the first embodiment, the correspondence is set so that the data resource pool set in each of the plurality of carriers is uniquely determined with respect to the SCI resource pool set in the specific carrier. In the example of FIG. 10, a data resource pool 3 set in a carrier 3 uniquely corresponds to an SCI resource pool 1 set in a carrier 1. In addition, a data resource pool 2 set in the carrier 2 uniquely corresponds to an SCI resource pool 2 set in the carrier 1. Further, a data resource pool 1 set in the carrier 1 uniquely corresponds to an SCI resource pool 3 set in the carrier 1.

The setting of each resource pool and the corresponding relationship amongst each of the resource pools are set in the user apparatus UE by a plurality of setting methods described in the following.

(First Setting Method)

According to a first setting method, a base station eNB uses RRC signaling or broadcast information transmitted by a carrier in which the SCI resource pool is set, and the base station sets setting information of the SCI resource pool, setting information of a data resource pool of each carrier, and information indicating a corresponding relationship between the SCI resource pool and the data resource pool to the user apparatus UE. In this case, the setting of the data resource pool includes information (such as a carrier frequency, a carrier index, and the like) that specifies the carrier in which this data resource pool is set.

The user apparatus UE receives the RRC signaling or the broadcast information transmitted by the carrier in which the SCI resource pool is set, and the user apparatus UE recognizes the setting of each of the resource pools and the corresponding relationship of each of the resource pools.

The corresponding relationship between the SCI resource pool and the data resource pool may be indicated by a combination of numbers, for example, by using a number (or a sequence of numbers) assigned to the SCI resource pool and a number assigned to the data resource pool. In addition, it is possible to implicitly indicate the correspondence of the SCI resource pool and the data resource pool that are assigned identical numbers.

(Second Setting Method)

According to a second setting method, a base station eNB transmits setting information of the resource pools for every carrier to a user apparatus UE. The base station eNB transmits separately for every carrier using the RRC signaling or the broadcast information. In addition, the base station eNB sets the information indicating the corresponding relationship of the resource pools to the user apparatus UE by including this information in the RRC signaling or the broadcast information transmitted by each carrier. Hence, the setting of each carrier may be committed to the setting contents of each resource pool to secure a degree of freedom of setting each carrier.

The user apparatus UE receives the RRC signaling or the broadcast information transmitted in each carrier and recognizes the corresponding relationship between the setting of each resource pool and each resource pool.

A description will be given of a specific example using FIG. 10. In order to simplify the description, it is assumed that only the carrier 1 and the carrier 2 exist (that is, the SCI resource pool 1 and the data resource pool 3 do not exist) in FIG. 10. First, the base station eNB transmits setting information of the SCI resource pool 2, setting information of the SCI resource pool 3, setting information of the data resource pool 1, information indicating that the SCI resource pool 2 and the data resource pool 2 are in a corresponding relationship, and information indicating that the SCI resource pool 3 and the data resource pool 1 are in a corresponding relationship, to the user apparatus UE using the RRC signaling or the broadcast information transmitted by the carrier 1.

The information indicating that the SCI resource pool 2 and the data resource pool 2 are in the corresponding relationship may be included in the setting information of the SCI resource pool 2. For example, the setting information of the SCI resource pool 2 may include an index number indicating the data resource pool 2 and/or information specifying the carrier of the data resource pool 2, and the like. Similarly, the information indicating that the SCI resource pool 3 and the data resource pool 1 are in the corresponding relationship may be included in the setting information of the SCI resource pool 3.

Next, the base station eNB transmits the setting information of the data resource pool 2, and the information indicating that the SCI resource pool 2 and the data resource pool 2 are in the corresponding relationship to the user apparatus UE using the RRC signaling or the broadcast information transmitted in the carrier 2. The information indicating that the SCI resource pool 2 and the data resource pool 2 are in the corresponding relationship may be included in the setting information of the data resource pool 2. For example, the setting information of the data resource pool 2 may include an index number indicating the SCI resource pool 2 and/or information specifying the carrier of the SCI resource pool 2.

(Third Setting Method)

According to a third setting method, setting information of the resource pools of each carrier, and information indicating the corresponding relationship between the resource pools are preset (pre-configured) in the user apparatus UE by a Subscriber Identity Module (SIM) and the like.

(Operation Example of User Apparatus)

A description will be given of an operation example of the user apparatus UE by referring to FIG. 10. It is a precondition that the setting information of the resource pools of each carrier, and the information indicating the corresponding relationship between the resource pools, are set in the user apparatus UE. A description will be given of a case in which it is assumed that the transmission end user apparatus UE1 transmits the data using the resource 3b of the data resource pool 3.

The transmission end user apparatus UE1 selects a resource 1a within the SCI resource pool 1, and further selects the resource 3b of the data resource pool 3 in correspondence with the SCI resource pool 1. Next, the user apparatus UE1 transmits the SCI specifying the resource 3b and the like, using the selected resource 1a. Then, the user apparatus UE1 transmits the data, using the resource 3b of the data resource pool 3.

When the reception end user apparatus UE2 receives the SCI by monitoring the SCI resource pool 1, the user apparatus UE2 recognizes that the resource 3b specified by this SCI is the resource of the data resource pool 3 of the carrier 3, based on the information indicating the corresponding relationship between the resource pools. Then, the user apparatus UE2 receives the data by monitoring the resource 3b.

According to the first embodiment described before, the user apparatus UE can monitor the SCI solely by a specific carrier, even in an environment in which the D2D communication is performed using a plurality of carriers.

In addition, in the first embodiment, the data link pool is made to uniquely correspond to the SCI resource pool. Accordingly, in a situation in which it is determined in advance between the user apparatuses UEs that the data is transmitted and received solely by the specific carrier, the user apparatus UE can limit a range of the SCI resource pool to be constantly monitored, and reduce the power consumption.

### Second Embodiment

In the second embodiment, the transmission end user apparatus UE1 transmits the SCI by the SCI resource pool of the specific carrier. In addition, the transmission end user apparatus UE1 includes, in the SCI, information indicating the carrier of the data to which the SCI is related. In other words, in the second embodiment, the reception end user apparatus UE2 recognizes the data of the carrier to which the SCI is related, using the above information included in the SCI.

More particularly, the information indicating the data of the carrier to which the SCI is related, is information (a carrier frequency, a carrier index, and the like, and is basically the same in each of the following embodiments) specifying the carrier. In a case in which the carrier index is used as the information specifying the carrier, the carrier index may have k bits, for example. Such a carrier index may identify 2^{k} carriers.

In the second embodiment, unlike the first embodiment, a plurality of data resource pools are made to correspond to the SCI resource pool.

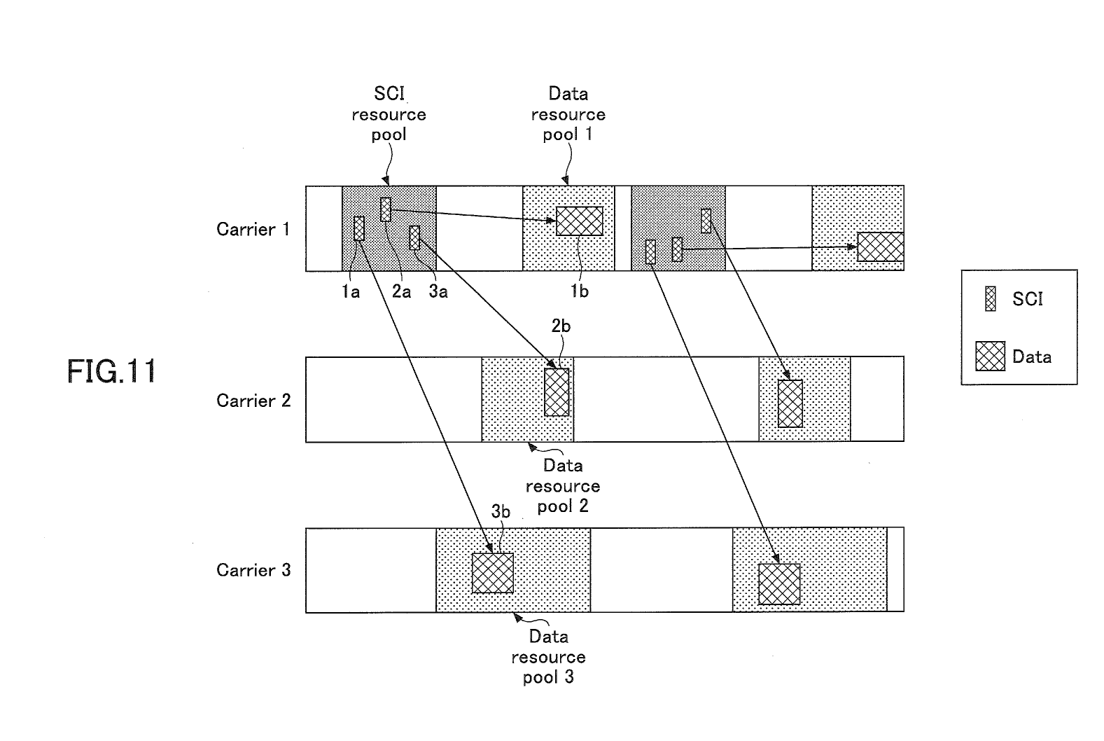

FIG. 11 is a diagram for explaining the D2D signal transmission method in the second embodiment. In the example illustrated in FIG. 11, all of the data resource pool 1 set in the carrier 1, the data resource pool 2 set in the carrier 2, and the data resource pool 3 set in the carrier 3 correspond to the SCI resource pool 1 set in the carrier 1.

The setting of each resource pool and the corresponding relationship amongst each of the resource pools are set in the user apparatus UE by a plurality of setting methods described in the following.

(First Setting Method)

According to a first setting method, the base station eNB uses a RRC signaling or a broadcast information transmitted by the carrier in which the SCI resource pool is set, and sets setting information of the data resource pool of each carrier and information indicating the corresponding relationship between the SCI resource pool and the data resource pool to the user apparatus UE.

The user apparatus UE receives the RRC signaling or the broadcast information transmitted by the carrier where the SCI resource pool is set, and recognizes the setting of each of the resource pools and the corresponding relationship of each of the resource pools.

The corresponding relationship between the SCI resource pool and the data resource pool may be indicated by a combination of numbers, for example, by using the number (for example, the sequence number) assigned to the SCI resource pool and the number assigned to the data resource pool.

(Second Setting Method)

According to a second setting method, the base station eNB transmits the setting information of the resource pools for every carrier to the user apparatus UE using the RRC signaling or the broadcast information. In addition, the base station eNB sets the information indicating the corresponding relationship of the resource pools to the user apparatus UE, by including this information in the RRC signaling or the broadcast information transmitted by each carrier. Unless otherwise indicated, this second setting method may be the same as the second setting method of the first embodiment.

A description will be given of a specific example using FIG. 11. In order to simplify the description, it is assumed that only the carrier 1 and the carrier 2 exist (that is, the data resource pool 3 does not exist) in FIG. 11. The base station eNB transmits the setting information of the SCI resource pool, the setting information of the data resource pool 1, and the information indicating that the SCI resource pool and the data resource pools 1 to 3 are in a corresponding relationship, to the user apparatus UE using the RRC signaling or the broadcast information transmitted by the carrier 1. The information indicating that the SCI resource pool and the data resource pools 1 to 3 are in the corresponding relationship may be included in the setting information of the SCI resource pool. For example, the setting information of the SCI resource pool may include index numbers indicating the data resource pools 1 to 3 and/or information specifying the carriers of the data resource pools 1 to 3.

In addition, the base station eNB transmits the setting information of the data resource pool 2, and the information indicating that the SCI resource pool and the data resource pool 2 are in the corresponding relationship, to the user apparatus UE using the RRC signaling or the broadcast information transmitted by the carrier 2. The information indicating that the SCI resource pool and the data resource pool 2 are in the corresponding relationship may be included in the setting information of the data resource pool 2. For example, the setting information of the data resource pool 2 may include the index number indicating the SCI resource pool and/or information specifying the carrier of the SCI resource pool.

(Third Setting Method)

A third setting method may be the same as the third setting method of the first embodiment, and a description thereof will be omitted.

(Operation Example of User Apparatus)

A description will be given of an operation example of the user apparatus UE, by referring to FIG. 11. It is a precondition that the setting information of the resource pools of each carrier and the information indicating the corresponding relationship between the resource pools, are set in the user apparatus UE. A description will be given of a case in which it is assumed that the transmission end user apparatus UE1 transmits the data using the resource 3b of the data resource pool 3.

The transmission end user apparatus UE1 selects the resource 1a within the SCI resource pool, and further selects the resource 3b of the data resource pool 3 in correspondence with the SCI resource pool. Next, the user apparatus UE1 transmits the SCI including information specifying a carrier index indicating the carrier 3, a position of the resource 3b, and the like, using the selected resource 1a. Then, the user apparatus UE1 transmits the data, using the resource 3b of the data resource pool 3.

When the reception end user apparatus UE2 receives the SCI by monitoring the SCI resource pool 1, the user apparatus UE2 recognizes that the resource 3b specified by this SCI is the resource of the carrier 3, based on the information specifying the carrier index indicating the carrier, the position of the resource 3b, and the like included in this SCI. Then, the user apparatus UE2 receives the data by monitoring the resource 3b.

According to the second embodiment described before, the user apparatus UE can monitor the SCI solely by a specific carrier, even in an environment in which the D2D communication is performed using a plurality of carriers.

### Third Embodiment

In a third example embodiment, the user apparatus UE transmits the SCI by the resource within the SCI resource pool of the specific carrier, and enables the data of a plurality of carriers to be related to a single SCI. In other words, in the third embodiment, the user apparatus UE can transmit the data spanning the plurality of carriers by making the data correspond (relating the data) to the single SCI.

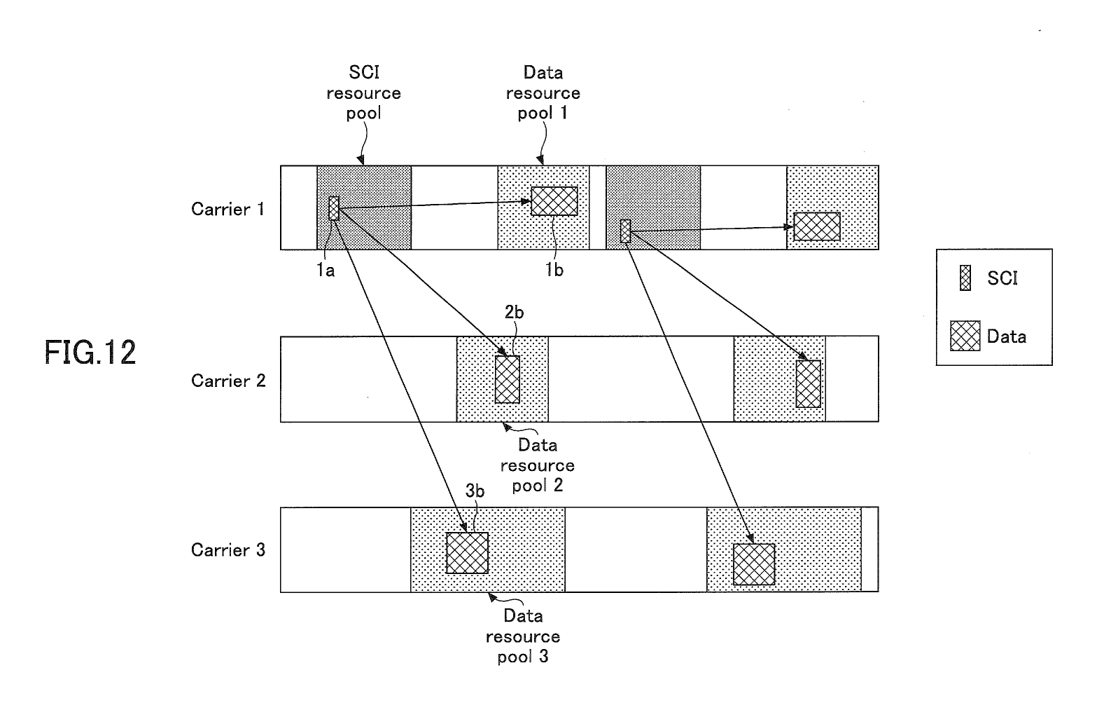

FIG. 12 is a diagram for explaining the D2D signal transmission method in the third embodiment. As illustrated in FIG. 12, the SCI transmitted by the resource 1a is made to correspond to the data transmitted by the resources 1b to 3b of the carriers 1 to 3. The data transmitted by the resources 1b to 3b may respectively be identical data, or may respectively be mutually different data.

Whether the plurality of data corresponding to the SCI are identical data or different data, may be preset in the reception end user apparatus UE2 by the RRC signaling or the broadcast information from the base station eNB. In addition, whether the plurality of data corresponding to the SCI are identical data or different data, may be determined by the transmission end user apparatus UE1, by including an identification bit (for example, 1 bit) in the SCI. The reception end user apparatus UE2 can recognize whether the plurality of data corresponding to the SCI are identical data or different data, by referring to this identification bit.

The setting of each resource pool and the corresponding relationship amongst each of the resource pools are set in the user apparatus UE by a plurality of setting methods described in the following.

(First Setting Method)

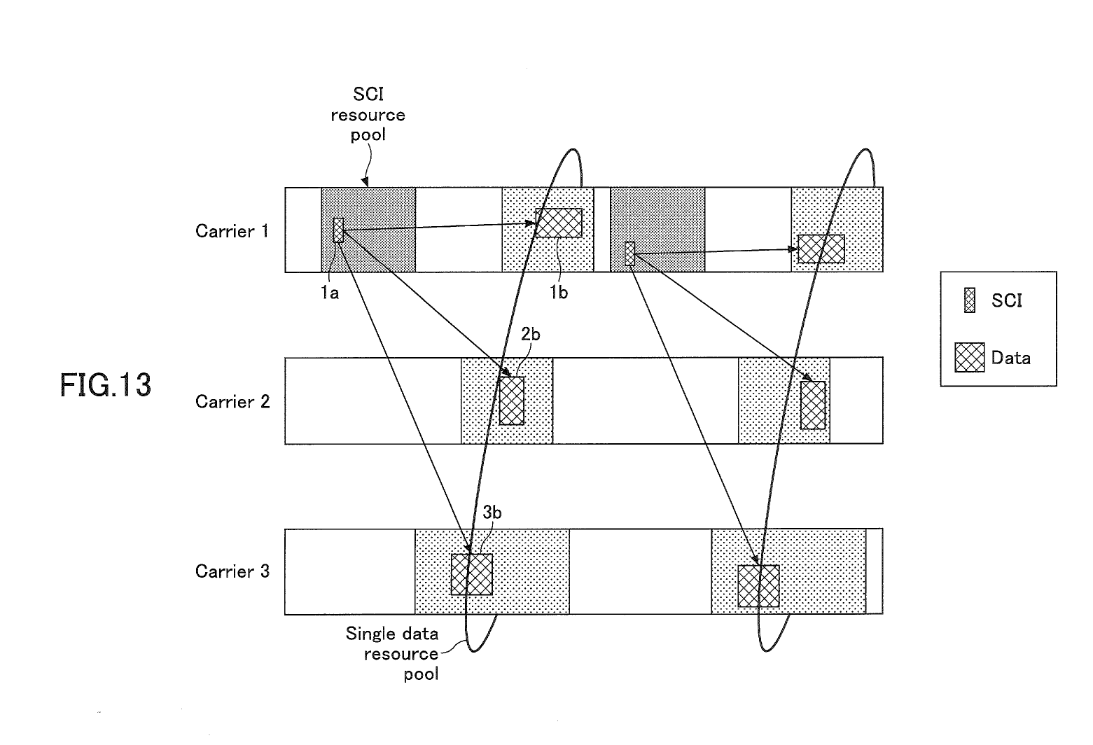

According to a first setting method, the SCI resource pool is set in a specific carrier, and a single data resource pool spanning a plurality of carriers is set as the data resource pool corresponding to this SCI resource pool. More particularly, as illustrated in FIG. 13, the SCI resource pool is set in the carrier 1, and the single data resource pool spanning the carriers 1 to 3 is set. In order to enable setting of such a data resource pool, the setting information of the data resource pool includes the time and the frequency resource for every carrier.

The base station eNB may set the setting information of the SCI resource pool, the setting information of the data resource pool, and the information indicating the corresponding relationship between the resource pools, to the user apparatus UE, using the RRC signaling or the broadcast information transmitted by the carrier (the carrier 1 in the example of FIG. 13) in which the SCI resource pool is set.

In addition, the base station eNB may set the setting information of the data resource pool and the corresponding relationship between the resource pools, to the user apparatus UE, using the RRC signaling or the broadcast information transmitted by each of the carriers (the carriers 2 and 3 in the example of FIG. 13) in which the data resource pool is set.

Further, the setting information of the SCI resource pool, the setting information of the data resource pool, and the information indicating the corresponding relationship between the resource pools, may be preset in the user apparatus UE by the SIM and the like.

In the case of the first setting method, information indicating a plurality of resource positions (time and frequency resource) is included in the SCI. In the example of FIG. 13, the position (time and frequency) of the resource 1b, the position (time and frequency) of the resource 2b, and the position (time and frequency) of the resource 3b are included in the SCI.

(Second Setting Method)

i.According to a second setting method, the SCI resource pol is set in the specific carrier, and the data resource pool is set in each of the plurality of carriers, similarly as in the case of the second embodiment. In addition, this SCI resource pool is made to correspond to the data resource pool of each of the plurality of carriers. The specific method of setting the resource pool in the user apparatus UE may be the same as the first setting method and the second setting method of the second embodiment, and a description thereof will be omitted.

In the case in which the second setting method is applied, information indicating a resource position (time and frequency resource) of each carrier is included in the SCI. In the example of FIG. 12, a carrier index of the carrier 1, a position (time and frequency) of the resource 1b, a carrier index of the carrier 2, a position (time and frequency) of the resource 2b, a carrier index of the carrier 3, and a position (time and frequency) of the resource 3b are included in the SCI.

(Operation Example of User Apparatus)

A description will be given of an operation example of the user apparatus UE for the case in which the second setting method is applied, by referring to FIG. 12. It is a precondition that the setting information of the resource pool of each carrier, and the information indicating the corresponding relationship between the resource pools, are set in the user apparatus UE. A description will be given of a case in which it is assumed that the transmission end user apparatus UE1 transmits the data using the resources 1b to 3b.

The transmission end user apparatus UE1 selects the resource 1a within the SCI resource pool, and further, selects the resource 1b of the data resource pool, the resource 2b of the data resource pool 2, and the resource 3b of the data resource pool 3 that are made to correspond to the SCI resource pool. Next, the user apparatus UE1 transmits the SCI including the information indicating the positions and the like of the resources 1b to 3b, using the selected resource 1a. Then, the user apparatus UE1 transmits the data using the resources 1b to 3b.

When the reception end user apparatus UE2 receives the SCI by the SCI resource pool, the reception end user apparatus UE2 receives the data by monitoring the resources 1b to 3b specified by this SCI, based on the information of the positions and the like of the resources 1b to 3b included in the SCI.

According to the third embodiment described heretofore, the user apparatus UE can monitor the SCI solely by a specific carrier, even in an environment in which the D2D communication is performed using a plurality of carriers. In addition, the user UE can transmit the data spanning the plurality of carriers by making the data correspond to a single SCI.

In addition, the reception end user apparatus UE can improve a reception accuracy by performing a combined reception and the like, in a case in which the plurality of data transmitted by the plurality of carriers are identical data.

### Fourth Embodiment

ii.In a fourth example embodiment, the user apparatus UE transmits the SCI by the specific carrier, and relates the data of the plurality of carriers to a single SCI. In other words, in the fourth embodiment, the user apparatus UE can transmit the data spanning the plurality of carriers by making the data correspond to the single SCI, similarly as in the case of the third embodiment.

In the first embodiment, the second embodiment, and the third embodiment, the SCI resource pool and the data resource pool corresponding to the SCI resource pool are separated in the time direction. On the other hand, instead of separating the SCI resource pool and the data resource pool corresponding to the SCI resource pool in the time direction, the fourth embodiment tolerates multiplexing the SCI resource pool and the data resource pool corresponding to the SCI resource pool. In other words, in the fourth embodiment, the user apparatus UE tolerates transmission of the SCI and the data in the same time region.

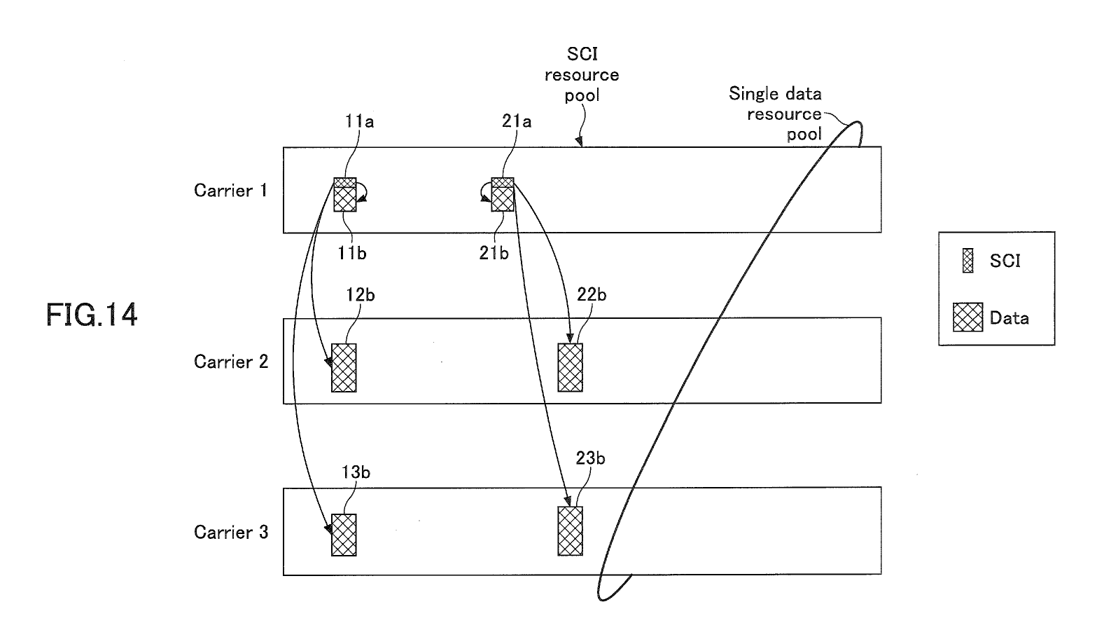

FIG. 14 is a diagram for explaining the D2D signal transmission method in the fourth embodiment. An example on the left side of FIG. 14 illustrates a case in which the SCI transmitted by a resource 11a is made to correspond to the data transmitted by resources 11b to 13b of the carriers 1 to 3, and the SIC and each data are transmitted at identical times (for example, identical sub-frames).

In addition, an example on the right side of FIG. 14 illustrates a case in which the SCI transmitted by a resource 21a is made to correspond to the data transmitted by resources 21b to 23b of the carriers 1 to 3, and the data transmitted by the resource 22b and the data transmitted by the resource 23b are transmitted at times different from the time when the SCI is transmitted. FIG. 14 merely illustrates an example, and in the fourth embodiment, the user apparatus UE may transmit the SCI and the plurality of data in various time regions.

The data transmitted by the resources 11b to 13b (and also data transmitted by the resources 21b to 23b) may respectively be identical data, or may respectively be different data, similarly as in the case of the third embodiment. In addition, whether the plurality of data corresponding to the SCI are identical data or different data, may be preset in the user apparatus UE by the RRC signaling or the broadcast information from the base station eNB, similarly as in the case of the third embodiment. Alternatively, whether the plurality of data corresponding to the SCI are identical data or different data, may be determined by the transmission end user apparatus UE1, by including the identification bit (for example, 1 bit) in the SCI, similarly as in the case of the third embodiment.

In the fourth embodiment, the information indicating the plurality of resource positions is included in the SCI. The information indicating the resource positions may include only the frequency resources, or may include the times and the frequency resources. For example, in the example on the left side of FIG. 14, the position (frequency) of the resource 11b, the position (frequency) of the resource 12b, and the position (frequency) of the resource 13b may be included in the SCI that is transmitted by the resource 11a. In addition, in the example on the right side of FIG. 14, the position (frequency) of the resource 11b , the position (time and frequency) of the resource 12b, and the position (time and frequency) of the resource 13b may be included in the SCI that is transmitted by the resource 11a.

Next, a description will be given of a method of setting the resource pool in the fourth embodiment. In the fourth embodiment, the SCI resource pool is set in the specific carrier in its entirety, and the single data resource pool spanning the plurality of carriers in their entirety is set as the data resource pool corresponding to this SCI resource pool.

More particularly, as illustrated in FIG. 14, the SCI resource pool is set in the carrier 1 in its entirety, and the single data resource pool spanning the carriers 1 to 3 in their entirety is set. In order to enable setting of such a data resource pool, the frequency resources (for example, a bandwidth of the carrier 1, a bandwidth of the carrier 2, and a bandwidth of the carrier 3) for every carrier are included in the setting information of the data resource pool.

The method of setting the resource pool to the user apparatus UE may be similar to the first setting method of the third embodiment.

(Operation Example of User Apparatus)

A description will be given of an operation example of the user apparatus UE, by referring to FIG. 14. It is a precondition that the setting information of the resource pool of each carrier, and the information indicating the corresponding relationship between the resource pools, are set in the user apparatus UE. A description will be given of a case in which it is assumed that the transmission end user apparatus UE1 transmits the data using the resources 11b to 13b.

The transmission end user apparatus UE1 selects the resource 11a within the SCI resource pool, and selects the resources 11b to 13b of the data resource pool corresponding to the SCI resource pool. Next, the user apparatus UE1 transmits the SCI that includes information indicating the positions and the like of the resources 11b to 13b, using the selected resource 11a, and transmits the data using the selected resources 11b to 13b.

When the reception end user apparatus UE2 receives the SCI by the SCI resource pool, the user apparatus UE2 receives each data from the resources 11b to 13b specified by this SCI, based on the information of the positions and the like of the resources 11b to 13b included in this SCI.

In the fourth embodiment, the concept itself of the resource pool may be excluded. For example, it is possible to set in the user apparatus UE only the specific carrier used for the SCI transmission, and the corresponding relationship of the plurality of carriers for the data transmission corresponding to this specific carrier.

According to the fourth embodiment described before, the user apparatus UE can monitor the SCI solely by a specific carrier, even in an environment in which the D2D communication is performed using a plurality of carriers. In addition, the user UE can transmit the data spanning the plurality of carriers by making the data correspond to a single SCI. Further, in a case in which the amount of transmission data is small, the user apparatus UE can transmit both the SCI and the data using only the single carrier, and for this reason, it is possible to avoid an increase in a delay associated with the switching of the carrier.

### Fifth Embodiment

In a fifth example embodiment, the base station eNB allocates, to the user apparatus UE, the resource for transmitting the SCI and the data by spanning a plurality of carriers, and notifies the allocated resource to the user apparatus UE. The fifth embodiment extends the resource allocation method of Mode 1 described above in the summary of D2D.

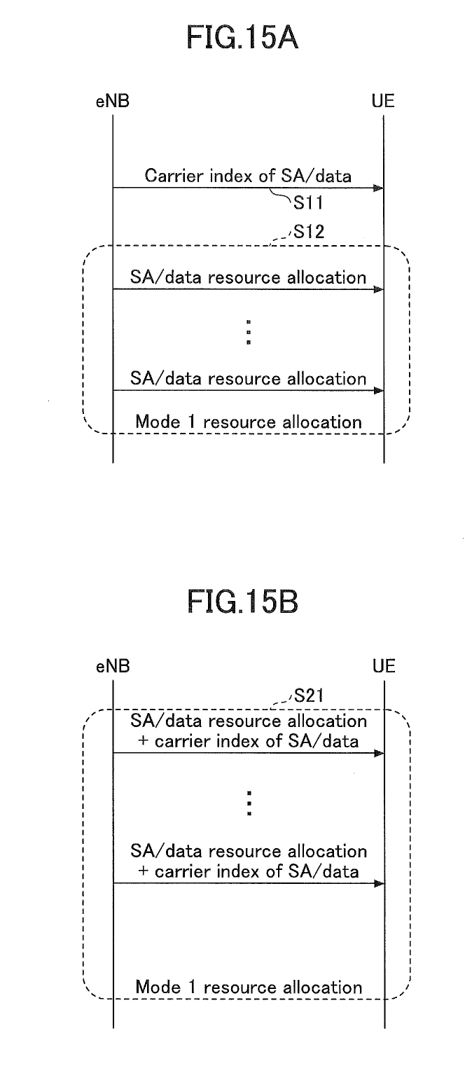

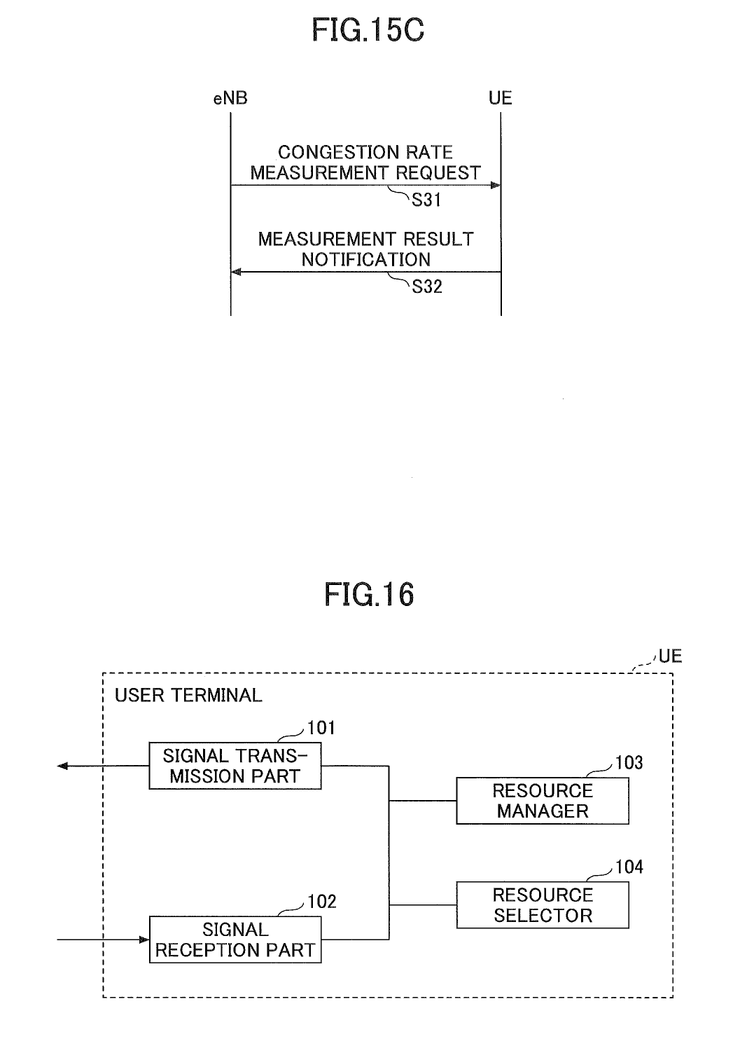

FIG. 15A, FIG. 15B and FIG. 15C are diagrams for explaining the resource allocation method in the fifth embodiment. In FIG. 15A, FIG. 15B, and FIG. 15C, it is a precondition that the base station eNB shares the information (for example, carrier index) for specifying the carrier with the user apparatus UE using the RRC signaling and/or the broadcast information, and that the user apparatus UE can recognize the carrier indicated by the carrier index.

In an example of FIG. 15A, the base station eNB instructs in advance the carrier to which the resource for transmitting the SCI and the data is allocated, to the user apparatus UE, and dynamically allocates the resource of the instructed carrier to the user apparatus UE using control information (for example, DCI (Downlink Control Information) and the like) transmitted by (E) PDCCH.

In step S11, the base station eNB notifies the carrier index to the user apparatus UE, by including the carrier index of the carrier to which the resource for transmitting the SCI is allocated, and/or the carrier index of the carrier to which the resource for transmitting the data is allocated, in the RRC signaling. The user apparatus UE stores the notified carrier index.

In step S12, the base station eNB notifies the information (resource allocation information) indicating the resource for transmitting the SCI allocated to the user apparatus UE and/or the resource for transmitting the data, to the user apparatus UE, using the control information transmitted by the (E) PDCCH. The user apparatus UE recognizes that the resource is allocated with respect to the carrier whose carrier index is stored in the processing procedure of step S11, and transmits the SCI and/or the data, using this carrier.

In a specific example, the base station eNB notifies the carrier index of the carrier 1 of FIG. 10, as the carrier to which the resource for transmitting the SCI is allocated, and notifies the carrier index of the carrier 2 of FIG. 10, as the carrier to which the resource for transmitting the data is allocated, for example, to the user apparatus UE (S11). Next, the base station eNB notifies the resource for transmitting the SCI and/or the resource for transmitting data, allocated to the user apparatus UE, to the user apparatus UE (S12). The user apparatus UE recognizes that the notified resource for transmitting the SCI is the resource of the carrier 1, and transmits the SCI using the resource of the carrier 1. In addition, the user apparatus UE recognizes that the notified resource for transmitting the data is the resource of the carrier 2, and transmits the data using the resource of the carrier 2.

In an example of FIG. 15B, unlike FIG. 15A, the base station eNB includes the information for specifying the carrier in the control information that is transmitted by the (E) PDCCH.

In step S21, the base station eNB notifies the information (resource allocation information) indicating the resource for transmitting the SCI and the carrier index, and/or the resource for transmitting data and the carrier index, allocated to the user apparatus UE, to the user apparatus UE, using the control information transmitted by the (E) PDCCH. The user apparatus UE transmits the SCI and/or the data, using the resource of the notified carrier.

The base station eNB may ascertain a congestion rate of each carrier using the processing procedure illustrated in FIG. 15C, before performing the processing procedure of FIG. 15A or FIG. 15B, and determine the resource of the carrier to which the user apparatus UE is allocated, based on the congestion rate of each carrier.

In step S31, the base station eNB requests the user apparatus UE to measure the congestion rate of each carrier for the D2D communication.

In step S32, the user apparatus UE measures the congestion rate of each carrier, and transmits a measured result to the base station eNB. The user apparatus UE may monitor the SCI resource pool and the data resource pool for a predetermined period, for example, and detect an extent of existence of the user apparatuses UEs transmitting the D2D signal, to measure the congestion rate of each carrier.

The congestion rate of each carrier may be indicated by a reception power, a reception quality, and the like. For example, an average reception power, an average reception quality, and the like in the resource pool of each carrier may be used as the congestion rate.

<Supplementary Matter Common to Each Embodiment>

A common resource pool (resource candidate) may be set in common for the SCI resource pool and the data resource pool, and the user apparatus UE may transmit the SCI and the data using this common resource pool.

The user apparatus UE that is restricted of its capability to simultaneously receive a plurality of carriers cannot simultaneously monitor the resources of the carriers exceeding the capability thereof. Accordingly, the user apparatus UE may monitor the SCI resource pool with a priority over the data resource pool in a case in which the SCI resource pool and the data resource pool overlap on the time base.

When making the SCI resource pool and the data resource pool correspond to each other, it is possible to set a rule to transmit the data a predetermined time later or to make the data resource pool correspond, after the SCI transmission or the SCI resource pool, in order to avoid simultaneous transmission and simultaneous reception of the SCI and the data.

In addition, in a case in which the user apparatus UE receives the SCI specifying the resources spanning the carriers exceeding the capability thereof, the user apparatus UE itself may select the data the user apparatus UE is to receive. Moreover, as another example, the transmission end user apparatus UE1 may set the priority of the data in the SCI, and the reception end user apparatus UE2 may receive the data having a highest priority based on this priority. Further, as another example, the priority of the data resource pools may be preset in the user apparatus UE by the RRC signaling and/or the broadcast information (or preset by the SIM and the like), and the user apparatus UE may receive the data transmitted by the data resource pool having the highest priority, based on this priority.

On the other hand, the user apparatus UE that is restricted of its capability to simultaneously “transmit” the data by the plurality of carriers, may decide the carriers by which the SCI and the data are to be transmitted, by the user apparatus UE itself.

In each embodiment, in a case in which a synchronization timing is off between each of the carriers (for example, the DFN and the SFN are not aligned between each of the carriers), the transmission end user apparatus U1 may include, in the SCI, a timing offset value (for example, a value indicating a relative error of the DFN and the SFN) related to the carrier of the resource specified by the SCI. In addition, this timing offset value may be notified from the base station eNB to the user apparatus UE by the RRC signaling or the broadcast information.

In a case in which the synchronization signal is transmitted and received between the user apparatuses UEs, monitoring of the synchronization signal is required in each carrier, and there is a possibility of reducing the effect of the SCI transmission and reception, that takes into consideration the capability of the user apparatus UE related to the number of simultaneously received carriers. For this reason, the synchronization signal transmitted and received between the user apparatuses UEs may be monitored only in the carrier identical to the carrier for monitoring the SCI, in order to establish synchronization in each of the carriers. In order to realize such an operation, the carrier for transmitting and receiving the synchronization signal that is transmitted and received between the user apparatuses UEs, the carrier to which a common synchronization reference is applicable, or/and a time offset value between the carriers, may be preset in the user apparatus UE. The setting information of these other carriers may be notified between the user apparatuses UEs using the PSBCH and the like.

<Functional Configuration>

A description will be given of examples of functional configurations of the user apparatus UE and the base station eNB that execute the operation of each of the embodiments described above. However, the user apparatus UE may execute a part (for example, only a specific one or a plurality of embodiments, and the like) of the process of the user apparatus UE described heretofore.

(User Apparatus)

FIG. 16 is a diagram illustrating an example of the functional configuration of the user apparatus in this embodiment. As illustrated in FIG. 16, the user apparatus UE includes a signal transmission part 101, a signal reception part 102, a resource manager 103, and a resource selector 104. FIG. 16 illustrates only the functional parts particularly related to this embodiment in the user apparatus UE, and although not illustrated, there are functions for at least performing an operation in conformance with the LTE. In addition, the functional configuration illustrated in FIG. 16 is merely one example. Functional classifications and names of the functional parts are not limited as long as the operation of this embodiment is executable thereby.

The signal transmission part 101 includes functions to generate various signals of a physical layer, from signals of a higher layer to be transmitted from the user apparatus UE, and transmit the various signals by radio transmission. In addition, the signal transmission part 101 includes a D2D signal transmission function, and a transmission function of cellular communication. Moreover, the signal transmission part 101 includes functions to transmit the D2D signal using one or more carrier.

Further, the signal transmission part 101 stores the information specifying the resource for transmitting the data, received from the resource selector 104, in the control information, and transmits this control information using the resource for transmitting the control information, selected by the resource selector 104. In addition, the signal transmission part 101 transmits the data using the resource for transmitting the data, selected by the resource selector 104. The control information may include the information for specifying the carrier. Moreover, the signal transmission part 101 may transmit the information indicating whether the data transmitted by the plurality of resources respectively are identical data or different data, by including this information in the control information.

The signal reception part 102 includes functions to receive various signals from other user apparatuses UEs or the base station eNB by radio reception, and acquire the signals of the higher layer from the received signals of the physical layer. In addition, the signal reception part 102 includes a D2D signal reception function, and a reception function of cellular communication. Moreover, the signal reception part 102 includes functions to receive the D2D signal using one or more carriers.

The resource manager 103 retains information related to the resource pools used for performing the data transmission and reception in the user apparatus UE (setting information of the resource pools, information indicating the corresponding relationship between the resource pools), and the like, based on the setting from the base station eNB or the presetting of the SIM and the like. This information related to the resource pools is used by the signal transmission part 101, the signal reception part 102, and the resource selector 104 for the signal transmission and reception.

The resource selector 104 selects the resource for transmitting the control signal, in the specific carrier. In addition, the resource selector 104 selects the resource for transmitting the data in one or more carriers. Moreover, the resource selector 104 may select the resource for transmitting the control information or/and the data within the resource pool (SCI resource pool, data resource pool) set in each carrier. The resource selector 104 generates the information specifying the resource for transmitting the data, and supplies this information to the signal transmission part 101.

Further, the resource selector 104 may select the resource for transmitting the control information and the resource for transmitting the data in identical time regions of each carrier.

(Base Station)

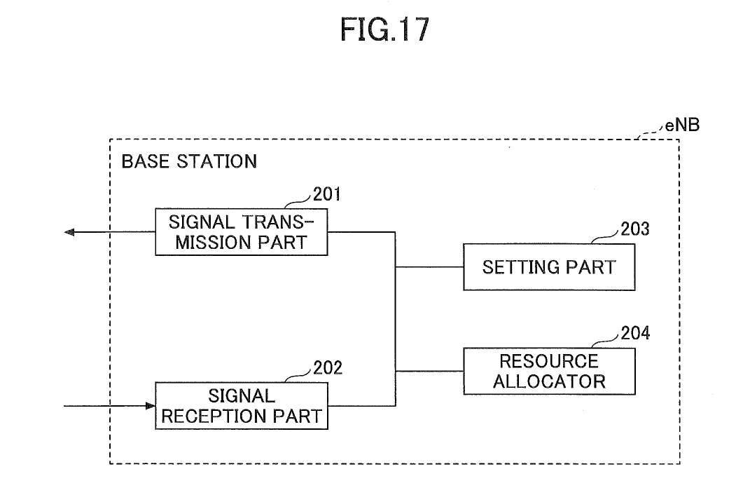

FIG. 17 is a diagram illustrating an example of a functional configuration of the base station in this embodiment. As illustrated in FIG. 17, the base station eNB includes a signal transmission part 201, a signal reception part 202, a setting part 203, and a resource allocator 204. FIG. 17 illustrates only the functional parts particularly related to this embodiment in the base station eNB, and although not illustrated, there are functions for at least performing an operation in conformance with the LTE. In addition, the functional configuration illustrated in FIG. 17 is merely one example. Functional classifications and names of the functional parts are not limited as long as the operation of this embodiment is executable thereby.

The signal transmission part 201 includes functions to generate various signals of the physical layer from the signals of the higher layer to be transmitted from the base station eNB, and transmit the various signals by radio transmission. In addition, the signal transmission part 201 transmits the information (resource allocation information) indicating the resource to which the user apparatus UE is allocated, received from the resource allocator 204, to the user apparatus UE.

Further, the signal transmission part 201 may transmit the information indicating the resource to which the user apparatus UE is allocated, to the user apparatus UE, using the control information and the like transmitted by the (E) PDCCH. In addition, the signal transmission part 201 may notify information indicating the resource of the carrier, indicated by the information indicating the resource allocated to the user apparatus UE, to the user apparatus UE using the RRC signal and the like. In addition, the signal transmission part 201 may transmit the information indicating the resource allocated to the user apparatus UE, by including in this information, information for specifying the carrier to which the resource is allocated.

The signal reception part 202 includes functions to receive various signals from the user apparatus UE by radio reception, and acquire the signals of the higher layer from the received signals of the physical layer.

The setting part 203 sets the information of the resource pool and the like used for the data transmission and reception at the user apparatus UE, to the user apparatus UE using the RRC signaling or the broadcast information (SIB).

The resource allocator 204 performs a resource allocation with respect to the control information and/or the data, with respect to the user apparatus UE. In addition, the resource allocator 204 performs a resource allocation for transmitting the control information in the specific carrier, with respect to the user apparatus UE. Further, the resource allocator 204 performs a resource allocation for transmitting the data in one or more carriers, with respect to the user apparatus UE. The resource allocator 204 generates information indicating the resource allocated to the user apparatus UE, and supplies this information to the signal transmission part 201.

The functional configurations of the user apparatus UE and the base station eNB described heretofore may be realized in their entirety by a hardware circuit (for example, one or a plurality of IC chips), or a part may be formed by a hardware circuit and other parts may be realized by a CPU and programs. As it would be understood by a person skilled in the art, the transmission part may be any type of device capable of performing the transmission function, for example, a transmitter.

(User Apparatus)

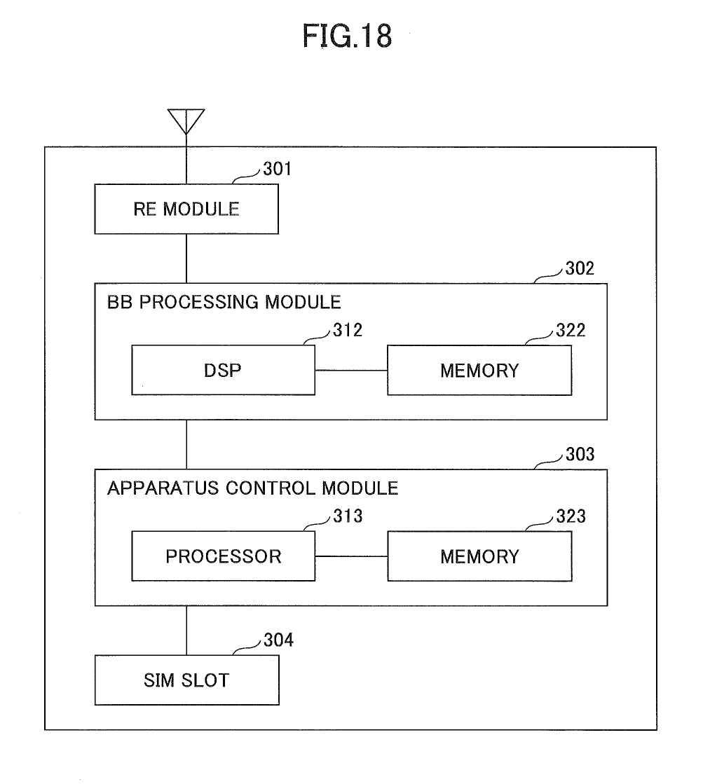

FIG. 18 is a diagram illustrating an example of a hardware configuration of the user apparatus in this embodiment. FIG. 18 illustrates a configuration closer to implementation than that of FIG. 16. As illustrated in FIG. 18, the user apparatus UE includes an Radio Equipment (RE) module 31 for performing processes related to radio signals, a Base Band (BB) processing module 302 for performing a baseband signal processing, an apparatus control module 303 for performing processes on the higher layer and the like, and an SIM slot 304 that is an interface for making access to the SIM card.

The RE module 301 generates radio signals to be transmitted from an antenna, by performing a Digital-to-Analog (D/A) conversion, a modulation, a frequency conversion, a power amplification, and the like with respect to a digital baseband signal received from the BB processing module 302. In addition, the RE module 301 generates a digital baseband signal by performing a frequency conversion, an Analog-to-Digital (A/D) conversion, a demodulation, and the like with respect to received radio signals, and supplies the generated digital baseband signal to the BB processing module 302. The RE module 301 includes a part of the signal reception part 102 and the signal transmission part 101 of FIG. 16, for example.

The BB processing module 302 performs a process to mutually convert between an IP packet and the digital baseband signal. A Digital Signal Processor (DSP) 312 is a processor for performing a signal processing in the BB processing module 302. A memory 322 is used as a work area of the DSP 312. The RE module 301 includes a part of the signal transmission part 101, a part of the signal reception part 102, and the resource selector 104 of FIG. 16, for example.

The apparatus control module 303 performs a protocol process of an IP layer, processing of various applications, and the like. A processor 313 is a processor for performing processes of the apparatus control module 303. A memory 323 is used as a work area of the processor 313. In addition, the processor 313 performs a read and a write of the data between the SIM via the SIM slot 304. The apparatus control module 303 includes the resource manager 103 of FIG. 16, for example.

(Base Station)

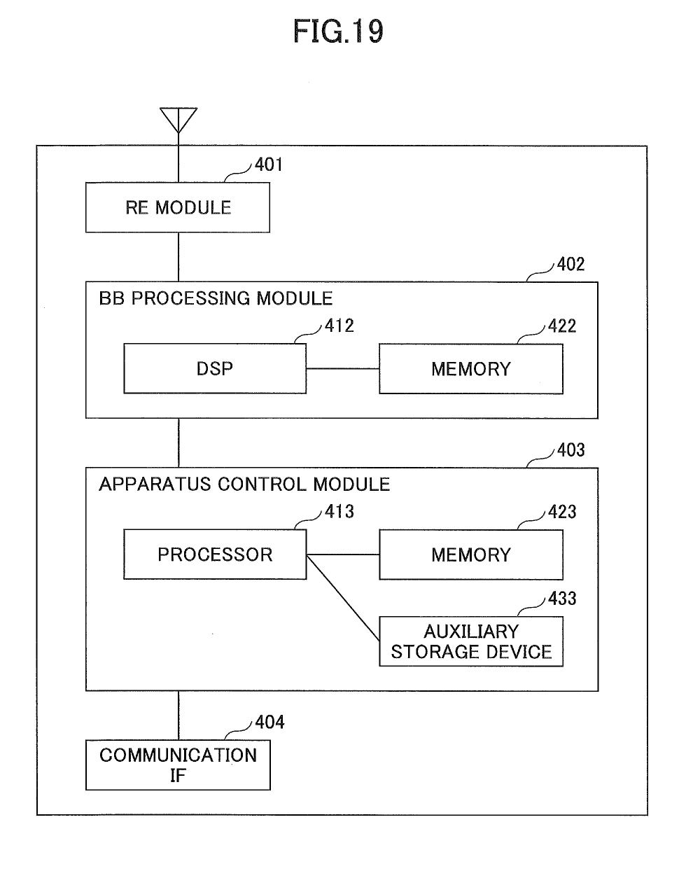

FIG. 19 is a diagram illustrating an example of a hardware configuration of the base station in this embodiment. FIG. 19 illustrates a configuration closer to implementation than that of FIG. 17. As illustrated in FIG. 19, the base station eNB includes an RE module for performing processes related to the radio signals, a BB processing module 402 for performing a baseband signal processing, an apparatus control module 403 for performing processes on the higher layer and the like, and a communication IF 404 that is an interface for making a connection to a network.

The RE module 401 generates radio signals to be transmitted from an antenna, by performing a D/A conversion, a modulation, a frequency conversion, a power amplification, and the like with respect to a digital baseband signal received from the BB processing module 402. In addition, the RE module 401 generates a digital baseband signal by performing a frequency conversion, an A/D conversion, a demodulation, and the like with respect to received radio signals, and supplies the generated digital baseband signal to the BB processing module 402. The RE module 401 includes a part of the signal reception part 202 and the signal transmission part 201 of FIG. 17, for example.

The BB processing module 402 performs a process to mutually convert between an IP packet and the digital baseband signal. A DSP 412 is a processor for performing a signal processing in the BB processing module 402. A memory 422 is used as a work area of the DSP 412. The RE module 401 includes a part of the signal transmission part 201, a part of the signal reception part 202, and the resource allocator 204 of FIG. 17, for example.

The apparatus control module 403 performs a protocol process of an IP layer, an OAM (Operation And Maintenance) process, and the like. A processor 413 is a processor for performing processes of the apparatus control module 403. A memory 423 is used as a work area of the processor 413. An auxiliary storage device 433 is an HDD and the like, for example, and stores various setting information and the like for operating the base station eNB itself. The apparatus control module 403 includes a part of the signal transmission part 201, a part of the signal reception part, and the setting part 203 of FIG. 17, for example.

(Summary)

According to the embodiments described above, there is provided a user apparatus in a radio communication system that supports a D2D communication, including a selector configured to select a first resource for transmitting control information in a first carrier, and a second resource for transmitting data in a second carrier, and a transmission part configured to transmit control information including information specifying the second resource using the first resource, and transmit data using the second resource. According to this user apparatus UE, in a case in which the D2D communication is performed using a plurality of carriers in the radio communication system that supports the D2D, it is possible to provide a technique to appropriately perform the D2D communication.

The selector may select the first resource in a resource pool for control information of the first carrier, and select the second resource in a resource pool for data in the second carrier corresponding to the resource pool for control information of the first carrier. In this case, the SCI resource pool is made to uniquely correspond to the data resource pool, and the user apparatus UE can limit a range of the SCI resource pool to be constantly monitored, and reduce the power consumption.

The control information may include information that specifies the second carrier. In this case, the reception end user apparatus UE2 can recognize the carrier in which the data is transmitted, by simply receiving the control information.

In addition, the selector may further select a third resource for transmitting the data in the first carrier, the control information may further include information that specifies the third resource, and the transmission part may further transmit the data using the third resource. In this case, it is possible to specify the resource for transmitting the data, spanning a plurality of carriers, by a single control information.

Further, the control information may include information indicating whether the data transmitted using the second resource, and the data transmitted using the third resource are identical data or different data. In this case, it is possible to make the reception end user apparatus UE recognize whether the data transmitted spanning a plurality of carriers are identical. Moreover, in a case in which identical data are transmitted spanning the plurality of carriers, the reception end user apparatus UE an improve the reception accuracy by performing a combined reception and the like.

The selector may select a third resource for transmitting the data in the first carrier in a time region identical to that of the first resource, and the transmission part may further transmit the data using the third resource. In this case, the resource can be selected flexibly at the user apparatus UE.

In addition, according to the embodiments described above, there is provided a base station in a radio communication system that supports a D2D communication, including a selector configured to allocate a first resource for transmitting control information in a first carrier of the D2D communication, and a second resource for transmitting data in a second carrier of the D2D communication, to a user apparatus, and a transmission part configured to transmit resource allocation information indicating the first resource and the second resource to the user apparatus. According to this base station eNB, in a case in which the D2D communication is performed using a plurality of carriers in the radio communication system that supports the D2D, it is possible to provide a technique to appropriately perform the D2D communication.

The resource allocation information may include information that specifies the first carrier to which the first resource is allocated, and information that specifies the second carrier to which the second resource is allocated. In this case, the base station eNB can simultaneously notify the resources allocated to the user apparatus UE and the carriers of the resources, to the user apparatus UE, and dynamically allocate the resources spanning the carriers.

In addition, according to the embodiments described above, there is provided a signal transmission method executed by a user apparatus in a radio communication system that supports a D2D communication, including step that selects a first resource for transmitting control information in a first carrier, and a second resource for transmitting data in a second carrier, and step that transmits control information including information specifying the second resource using the first resource, and transmits data using the second resource. According to this signal transmission method, in a case in which the D2D communication is performed using a plurality of carriers in the radio communication system that supports the D2D, it is possible to provide a technique to appropriately perform the D2D communication.

Further, according to the embodiments described above, there is provided a resource allocation method executed by a base station in a radio communication system that supports a D2D communication, including step that allocate a first resource for transmitting control information in a first carrier of the D2D communication, and a second resource for transmitting data in a second carrier of the D2D communication, to a user apparatus, and step that transmits resource allocation information indicating the first resource and the second resource to the user apparatus. According to this resource allocation method, in a case in which the D2D communication is performed using a plurality of carriers in the radio communication system that supports the D2D, it is possible to provide a technique to appropriately perform the D2D communication.

<Supplement to Embodiments>

An SC period is also referred to as an Scheduling Assignment (SA) period. In addition, the SCI is also referred to as an SA.

In addition, the SCI may be referred by other names as long as it is the control information used for the D2D communication.

The SCI resource pool (resource pool for SCI transmission) may be a resource pool of the PSCCH. Moreover, the data resource pool (resource pool for data transmission) may be a resource pool of the PSSCH. The carrier index may be referred to as a carrier indicator.

The PSCCH may be another control channel, as long as it is a control channel for transmitting the control information (SCI and the like) used for the D2D communication. The PSSCH may be another data channel, as long as it is a data channel for transmitting the data (MAC PDU and the like) used for the D2D communication. The PSDCH may be another data channel, as long as it is a data channel for transmitting the data (discovery message and the like) for the D2D communication of the D2D discovery.

Each apparatus (the user apparatus UE and/or the base station eNB) described in the embodiments of the present invention may include a

Central Processing Unit (CPU) and a memory, and may have a configuration realized by the CPU (or processor) that executes the program. Alternatively, each apparatus may have a configuration realized by hardware, such as a hardware circuit and the like provided with logic for the described process of the embodiments, or realized by a combination of program and hardware.

The disclosed invention is not limited to the embodiments of the present invention described above, and it may be apparent to those skilled in the art that various variations, modifications, substitutions, replacements, and the like may be made to the embodiments. Specific examples of numerical values are used in the description in order to facilitate understanding of the invention, however, these numerical values are simply illustrative, and any other appropriate values may be used, except where indicated otherwise. Classifications of items in the above description are not essential to the present invention, and depending on necessity, subject matter described in two or more items may be combined and used, and subject matter described in one item may be applied to subject matter described in another item (unless contradictory). A boundary of functional parts or processors in the functional block diagrams may or may not correspond to a boundary of physical components. An operation by a plurality of functional parts may be physically executed by a single component, or an operation of a single functional part may be physically executed by a plurality of components. For the sake of convenience, the user apparatus UE and/or the base station eNB are described using the functional block diagrams. However, these apparatuses may be implemented in hardware, software, or combinations thereof. The software that operates in the processor of the user apparatus UE according to the embodiments and the software that operates in the processor of the base station eNB according to the embodiments may be stored in any appropriate storage medium, such as a Random Access Memory (RAM), a flash memory, a Read Only Memory (ROM), an Erasable Programmable ROM (EPROM), an Electrically EPROM (EEPROM), a register, an Hard Disk Drive (HDD), a removable disk, a CD-ROM, a database, a server, and the like.

In each of the embodiments, the SCI resource pool is an example of a resource pool for control information. The data resource pool is an example of a resource pool for data.

### DESCRIPTION OF THE REFERENCE NUMERALS

UE User Apparatus
eNB Base Station
101 Signal Transmission Part
102 Signal Reception Part
103 Resource Manager
104 Resource Selector
201 Signal Transmission Part
202 Signal Reception Part
203 Setting Part
204 Resource Allocator
301 RE Module
302 BB Processing Module
303 Apparatus Control Module
304 SIM Slot
401 Re Module
402 BB Processing Module
403 Apparatus Control Module
404 Communication IF

1. A user apparatus in a radio communication system that supports a D2D communication, the user apparatus comprising:
a selector that selects a first resource to transmit control information in a first carrier, and a second resource to transmit data in a second carrier; and
transmitter that transmits control information that includes information to specify the second resource using the first resource, and to transmit data using the second resource.

2. The user apparatus as claimed in claim 1, wherein the selector:
selects the first resource in a resource pool for control information in the first carrier, and
selects the second resource in a resource pool for data in the second carrier that corresponds to the resource pool for control information in the first carrier.

3. The user apparatus as claimed in claim 1, wherein the control information includes information that specifies the second carrier.

4. The user apparatus as claimed in claim 1, wherein
the selector further selects a third resource to transmit data in the first carrier,
the control information further includes information that specifies the third resource, and the transmitter further transmits data using the third resource.

5. The user apparatus as claimed in claim 4, wherein the control information includes information that indicates whether the data transmitted using the second resource, and the data transmitted using the third resource are identical data or different data.

6. The user apparatus as claimed in claim 1, wherein
the selector selects a third resource to transmit data in the first carrier in a time region identical to that of the first resource, and
the transmitter further transmits data using the third resource.

7. A base station in a radio communication system that supports a D2D communication, the base station comprising:
a selector that allocates a first resource to transmit control information in a first carrier for the D2D communication, and a second resource to transmit data in a second carrier for the D2D communication, to a user apparatus; and
a transmitter configured to transmit resource allocation information to indicate the first resource and the second resource to the user apparatus.

8. The base station as claimed in claim 7, wherein the resource allocation information includes information that specifies the first carrier to which the first resource is allocated, and information that specifies the second carrier to which the second resource is allocated.

9. A signal transmission method executed by a user apparatus in a radio communication system that supports a D2D communication, the signal transmission method comprising:
selecting a first resource for transmitting control information in a first carrier, and a second resource for transmitting data in a second carrier; and
transmitting control information including information specifying the second resource using the first resource, and transmitting data using the second resource.

10. A resource allocation method executed by a base station in a radio communication system that supports a D2D communication, the resource allocation method comprising:
allocating a first resource for transmitting control information in a first carrier for the D2D communication, and a second resource for transmitting data in a second carrier for the D2D communication, to a user apparatus; and
transmitting resource allocation information indicating the first resource and the second resource to the user apparatus.
